(19) United States
(12) Patent Application Publication
(10) Pub. No.: US 2024/0411029 A1
(43) Pub. Date: Dec. 12, 2024

(54) Phase Multipath Mitigation in a Navigation Satellite Signal Receiver

(71) Applicant: Deere & Company, Moline, IL (US)

(72) Inventors: Gang Xie, Orange, CA (US); Brian C. Goodrich, Torrance, CA (US); Zhe Liu, Rancho Palos Verdes, CA (US)

(21) Appl. No.: 18/373,913

(22) Filed: Sep. 27, 2023

Related U.S. Application Data
(60) Provisional application No. 63/472,574, filed on Jun. 12, 2023.

(51) Int. Cl. G01S 19/22; G01S 19/29

(52) U.S. Cl. CPC G01S 19/22; G01S 19/29

(57) ABSTRACT

A Global Navigation Satellite System (GNSS) receiver receives a band-limited composite signal corresponding to a respective satellite in the GNSS. The composite signal is composed of a direct-path signal and a multipath signal. The receiver obtains, for a code chip edge transition of a pseudorandom code, correlation samples of the composite signal (I(t) samples and Q(t) samples) and compares them with a pre-determined filter characteristic (SR(t) samples) corresponding to a filter used to band limit the composite signal. Based on the comparison, the receiver determines a phase ϕ_{3rd} and/or a response time error of the code chip edge transition due to the multipath signal, Δt. The receiver adjusts a pseudorange measurement for the respective satellite and/or adjusts a carrier phase measurement for the respective satellite in accordance the determined ϕ_{3rd} and/or Δt. The receiver performs a navigation function using the adjusted pseudorange and/or carrier phase measurement for the respective satellite.

### RELATED APPLICATIONS

This application claims priority to U.S. Provisional Patent Application No. 63/472,574, filed Jun. 12, 2023, which is hereby incorporated by reference in its entirety.

### TECHNICAL FIELD

The disclosed embodiments relate generally to a global navigation satellite systems (GNSS) and more specifically, to systems and methods for mitigating multipath-induced errors in GNSS receiver positioning.

### BACKGROUND

Global Navigation Satellite Systems (GNSS), such as Global Positioning System (GPS), the Global Orbiting Navigation Satellite System (GLONASS), the European Galileo and EGNOS, Chinese BeiDou System (BDS), the Wide Area Augmentation System (WAAS), and Japanese Quasi-Zenith Satellite System (QZSS), are used in many applications. In a GNSS system, each satellite transmits a signal that identifies the satellite and allows a receiver to determine the time at which the signal was sent. To do so, a GNSS satellite transmits a pseudorandom code (PN code) (also called a pseudorandom noise code (PRN code)). The PN code is, for example, a series of ones and zeroes that looks random, but in fact uniquely identifies the satellite. The GNSS receivers acquire and track the GNSS satellite signals. From its code and carrier tracking loops, a GNSS receiver can then generate range or range rate measurements, such as pseudorange measurements, carrier phase measurements and doppler shift measurements. In some instances, using other data, such as ephemeris data and almanac data, that is encoded in the received signal, “on top of” the pseudorandom code, using various modulation schemes (e.g., BPSK, BOC), the receiver can determine the time at which the signal was sent by the satellite. Using signals received from four or more satellites, the receiver can determine its position (e.g., on Earth).

Multipath is one of the major error sources in GNSS. When a signal from a GNSS satellite to a GNSS receiver is reflected by surroundings (e.g., buildings, mountains, lakes, other objects, and/or the ground), this reflected signal, called a multipath, can also be received by the GNSS receiver. Therefore, a GNSS receiver can receive a composite of a line-of-sight direct-path signal and zero, one or more multiple signals from each satellite. Just like direct-path signals, multipath signals are also internally processed by GNSS receivers, thus introducing errors to code and carrier phase measurements and reducing GNSS positioning accuracy.

To improve GNSS range measurement accuracy and positioning accuracy, many techniques have been invented to mitigate or eliminate code multipath errors and carrier phase multipath errors. However, improving the performance of these multipath migration techniques, for example, their practicable implementation, reliability, effectiveness, and accuracy, is always of importance and of interest in the GNSS industry. Accordingly, there is a need for a technique to mitigate the effect of multipath-induced errors.

### SUMMARY

In accordance with some embodiments, a method of mitigating the effect of a multipath-induced error in a GNSS is performed at a respective GNSS signal receiver. The method includes receiving a band-limited composite signal corresponding to a respective satellite in the GNSS. The band-limited composite signal includes a band-limited direct-path signal and a band-limited multipath signal. The direct-path signal and the multipath signal are modulated with a pseudorandom (PN) code. The method includes obtaining, for a code chip edge transition of the PN code, n pairs of correlation samples of the composite signal during a corresponding n time instances, each having a different time offset from the code chip edge transition. The code chip edge transition has a predetermined filter step response function SR(t). Each respective pair of correlation samples of the n pairs of correlation samples consists of a respective in-phase component sample I(t₁) and a respective quadrature component sample Q(t₁), wherein i is a positive integer from one to n. The n pairs of correlation samples consist of n in-phase component samples of the composite signal (I(t) samples) and n quadrature component samples of the composite signal (Q(t) samples). The method includes obtaining, for each respective pair of correlation samples of the n pairs of correlation samples, a corresponding sample of the filter step response function SR(t₁) corresponding in time with the respective pair of correlation samples, thereby obtaining n samples of the filter step response function (predetermined SR(t) samples) during the corresponding n time instances. The method includes, in accordance with a determination that a computed similarity between the I(t) samples and the SR(t) samples satisfies a first threshold value, determining that a phase ϕ_{3rd} is ±90° within a first predefined margin, wherein the phase ϕ_{3rd} is equal to 180° minus a sum of (i) a carrier phase multipath error ϕe and (ii) a phase difference ϕₘ between the direct-path signal and the multipath signal. The method includes, in accordance with a determination that the computed similarity between the I(t) samples and the SR(t) samples does not satisfy the first threshold value: solving a first set of matrix equations, thereby obtaining a solution for tan ϕ_{3rd} and for Δt tan ϕ_{3rd}, wherein Δt is a response time error of the code chip edge transition due to the multipath signal. The method includes, in accordance with a determination that |tan ϕ_{3rd}| satisfies a second threshold value, determining that the phase ϕ_{3rd} is 0° or 180° within a second predefined margin. The method includes, in accordance with a determination that |tan ϕ_{3rd}| does not satisfy the second threshold value, determining ϕ_{3rd} in accordance with the solution for tan ϕ_{3rd}. The method includes adjusting a pseudorange measurement for the respective satellite in accordance with the determined Δt; and/or adjusting a carrier phase measurement for the respective satellite in accordance with a parameter corresponding to the determined ϕ_{3rd}. The method includes performing a navigation function using the adjusted pseudorange and/or the adjusted carrier phase measurement for the respective satellite.

In some embodiments, the method further includes determining a sign of the carrier phase multipath error ϕ_{ε}. The method incudes, in accordance with a determination that the computed similarity between the I(t) samples and the SR(t) samples satisfies the first threshold value: determining that ϕ_{3rd} is +90° within the first predefined margin when the sign of the carrier phase multipath error ϕ_{ε} is positive; and determining that ϕ_{3rd} is −90° within the first predefined margin when the sign of the carrier phase multipath error ϕ_{ε} is negative.

In some embodiments, the method further includes, in accordance with a determination that the phase ϕ_{3rd} is 0° or 180° within the second predefined margin: determining a position of a peak of the I(t) samples relative to a position of a peak of the predetermined SR(t) samples. The method includes, in accordance with a determination that the position of the peak of the I(t) samples occurs later in time than the position of the peak of the SR(t) samples, determining that ϕ_{3rd} is 0° within the second predefined margin; and in accordance with a determination that the position of the peak of the I(t) samples occurs earlier in time than the position of the peak of the predetermined SR(t) samples, determining that ϕ_{3rd} is 180° within the second predefined margin.

In some embodiments, the computed similarity between the I(t) samples and the SR(t) samples is obtained using a mean squared error (MSE), defined by

$${MSE}_{{A}_{I}} = \frac{1}{n} {\sum }_{i = 1}^{n} {[ I ( {t}_{i} ) - {A}_{I} SR ( {t}_{i} ) ]}^{2} ,$$

wherein A_{I}=A_{d} cos ϕ_{ε}, A_{d} is a magnitude of the direct-path signal, and ϕ_{ε} is the carrier phase multipath error.

In some embodiments, solving the first set of matrix equations includes obtaining (i) an initial estimate [symbol] for the phase ϕ_{3rd}, (ii) an initial estimate [symbol] for the response time error Δt, and (iii) an initial estimate [symbol] for a magnitude A_{d+m} of the composite signal; and using the initial estimates [symbol] [symbol] , and [symbol] to solve the first set of matrix equations via a Least Squares fitting process to obtain the solution for tan ϕ_{3rd} and Δt tan ϕ_{3rd}.

In some embodiments, the method further includes, in accordance with the determination that |tan ϕ_{3rd}| does not satisfy the second threshold value, obtaining a solution for tan ϕ_{3rd} and Δt tan ϕ_{3rd} via a first iterative process, each iteration of the first iterative process including: obtaining an updated estimate tan [symbol] for the phase ϕ_{3rd} and an updated estimate [symbol] for the response time error Δt. The method includes, in accordance with a determination that a number of iterations for which the first iterative process has looped satisfies a third threshold value: outputting information that no valid solution for ϕ_{3rd} has been determined; and terminating the first iterative process without producing a solution for ϕ_{3rd}. The method further includes, in accordance with a determination that a number of iterations for which the first iterative process has looped does not satisfy the third threshold value: in accordance with a determination that a magnitude based on the updated estimate [symbol] or based on the updated estimate tan [symbol] satisfies a fourth threshold value: determining that the Least Squares fitting process has converged; outputting the updated estimates tan [symbol] and the updated estimate [symbol] as the solutions for tan ϕ_{3rd} and Δt, respectively; calculating the phase ϕ_{3rd} from the updated estimate tan [symbol] ; and terminating the first iterative process. The method also includes, in accordance with a determination that (i) the magnitude based on the updated estimate [symbol] or based on the updated estimate tan [symbol] does not satisfy the fourth threshold value, performing a next iteration of the first iterative process.

In some embodiments, the method further includes, in accordance with a determination that a valid solution for the phase ϕ_{3rd} has been determined: determining (i) an initial estimate [symbol] for A_{I}, wherein A_{I}=A_{d} cos ϕ_{ε}, A_{d} is a magnitude of the direct-path signal, and ϕ_{ε} is the carrier phase multipath error; (ii) an initial estimate [symbol] for a magnitude A_{Q}, wherein A_{Q}=A_{d} sin ϕ_{ε}; (iii) an initial estimate [symbol] for a magnitude Aₘ of the multipath signal, and (iv) an initial estimate [symbol] for a time delay δ of the multipath signal relative to the direct-path signal, or determine a subset of those initial estimates. The method includes using at least a subset of (i) the initial estimate [symbol] (ii) the initial estimate [symbol] (iii) the initial estimate [symbol] and (iv) the initial estimate [symbol] as starting values, performing one or more iterative processes to obtain solutions for at least a subset of A_{I}, A_{Q}, Aₘ, and δ; computing the carrier phase multipath error ϕ_{ε} in accordance with the obtained solutions for at least the subset of A_{I}, A_{Q}, Aₘ, and δ; and correcting the carrier phase measurement for the respective satellite in accordance with the carrier phase multipath error ϕ_{ε}.

In some embodiments, the method further includes, in accordance with a determination that a valid solution for the phase ϕ_{3rd} has been determined: determining (i) an initial estimate [symbol] for A_{I}, wherein A_{I}=A_{d} cos ϕ_{ε}, A_{d} is a magnitude of the direct-path signal, and ϕ_{ε} is the carrier phase multipath error; (ii) an initial estimate [symbol] for a magnitude A_{Q}, wherein A_{Q}=A_{d} sin ϕ_{ε}; (iii) an initial estimate [symbol] for a magnitude Aₘ of the multipath signal, and (iv) an initial estimate [symbol] for a time delay δ of the multipath signal relative to the direct-path signal.

In some embodiments, in accordance with a determination that the code chip edge transition is a code chip edge-up transition: the initial estimate [symbol] corresponds to a magnitude of a last in-phase component sample I(tₙ) of the I(t) samples; and the initial estimate [symbol] corresponds to a magnitude of a last quadrature component Q(tₙ) of the Q(t) samples.

In some embodiments, in accordance with the code chip edge transition is a code chip edge-down transition: the initial estimate [symbol] corresponds to a magnitude of a first in-phase component sample I(t₁) of the I(t) samples; and the initial estimate [symbol] corresponds to a magnitude of a first quadrature component Q(t₁) of the Q(t) samples.

In some embodiments, the method includes, in accordance with the determination that the phase ϕ_{3rd} corresponds to ±90° within the first predefined margin: obtaining a solution for A_{I} by solving a matrix equation

$$[ \begin{matrix}SR ( {t}_{1} ) \\ SR ( {t}_{2} ) \\ ⋮ \\ SR ( {t}_{n} )\end{matrix} ] {A}_{I} = [ \begin{matrix}I ( {t}_{1} ) \\ I ( {t}_{2} ) \\ ⋮ \\ I ( {t}_{n} )\end{matrix} ] ;$$

and assigning the obtained solution as the initial estimate [symbol] .

In some embodiments, the method includes, in accordance with the determination that the phase ϕ_{3rd} is 0° or 180° within the second predefined margin: assigning the initial estimate [symbol] as zero.

In some embodiments, the initial estimate [symbol] is 0.5.

In some embodiments, the method further includes, in accordance with the determination that the phase ϕ_{3rd} does not correspond to ±90° within the first predefined margin: using the initial estimates [symbol] , [symbol] , and [symbol] as starting values to obtain a solution for A_{I}, Aₘ, and δ via a second iterative process, wherein k is a positive integer representing a number of iterations of the second iterative process. A k^{th} iteration of the second iterative process includes: obtaining n estimated in-phase component values (Î(tₖ₋₁) values) for the I(t) samples based on estimates [symbol] , [symbol] , and [symbol] from a previous (k−1)^{th} iteration of the second iterative process; determining, for each estimated in-phase component value Î(t_{i,k-1}) of the Î(tₖ₋₁) values, a corresponding in-phase component estimation error y_{I}(t_{i,k}) between (i) the respective estimated in-phase component value Î(t_{i,k-1}) and (ii) the respective in-phase component sample I(tᵢ) of the I(t) samples, thereby obtaining n in-phase component estimation errors (y_{I}(tₖ) estimation errors); solving a second set of matrix equations based on the y_{I}(tₖ) estimation errors, thereby obtaining updated estimates [symbol] , [symbol] , and [symbol] for the k^{th} iteration. The method includes, in accordance with a determination that (i) the updated estimate [symbol] is within a corresponding first valid range and (ii) the updated estimate [symbol] is within a corresponding second valid range: in accordance with a determination that the number of iterations k satisfies a fifth threshold value: in accordance with a determination that a change in value of one or more predetermined first parameters between the k^{th} iteration and the (k−1)^{th} iteration satisfies a respective corresponding threshold: determining that the second iterative process has converged; outputting the updated estimates [symbol] , [symbol] , and [symbol] as the solution for Aᵢ, Aₘ, and δ, respectively; and terminating the second iterative process. The method includes, in accordance with the determination that the change in value of the one or more predetermined parameters between the k^{th} iteration and the (k−1)^{th} iteration does not satisfy the respective corresponding threshold, performing a next iteration of the second iterative process. The method includes, in accordance with the determination that (i) the number of iterations k does not satisfy the fifth threshold value, terminating the second iterative process without producing a solution for A_{I}, Aₘ, and δ.

In some embodiments, the method includes, in accordance with a determination that (i) the updated estimate [symbol] is not within the corresponding first valid range or (ii) the updated estimate [symbol] is not within the corresponding second valid range: adjusting the initial estimate for the time delay δ from [symbol] to [symbol] ; and executing the second iterative process using the initial estimates [symbol] and [symbol] and the adjusted initial estimate [symbol] as the starting values.

In some embodiments, the method includes using the initial estimates [symbol] and [symbol] and the adjusted initial estimate [symbol] as the starting values for the second iterative process (e.g., restarted from the beginning, with k=1). The method includes, in accordance with a determination that (i) the updated estimate [symbol] is not within the corresponding first valid range or (ii) the updated estimate [symbol] is not within the corresponding second valid range: in accordance with a determination that a next adjusted value for the time delay would fall within a range of time values for the n pairs of correlation samples, repeating the steps of adjusting the initial estimate for the time delay δ and executing the second iterative process; and otherwise, outputting information that no valid solution for A_{I}, Aₘ, and δ has been determined.

In some embodiments, the method includes, after outputting the updated estimates [symbol] , [symbol] , and [symbol] as the solution for A_{I}, Aₘ, and δ, respectively, and in accordance with the determination that the phase ϕ_{3rd} is 0° or 180° within the second predefined margin: assigning a value of zero as the solution for A_{Q}.

In some embodiments, the method includes determining the carrier phase multipath error ϕe based on the solutions for A_{I} and A_{Q}; and correcting a pseudorandom phase measurement for the respective satellite in accordance with the carrier phase multipath error ϕe.

In some embodiments, the method includes, after outputting (e.g., at an end of the second iterative process) the updated estimates [symbol] , [symbol] , and [symbol] as the solution for A_{I}, Aₘ, and δ, respectively, and in accordance with the determination that the phase ϕ_{3rd} is not 0° or 180° within the second predefined margin: starting with the initial estimate for [symbol] , obtaining a solution for A_{Q} via a third iterative process, wherein k is a positive integer representing a number of iterations of the third iterative process (e.g., k is set or reset to 1 at beginning of the third iterative process). A k^{th} iteration of the third iterative process includes: obtaining n estimated quadrature component values (\hat{Q}(tₖ₋₁) values) for the Q(t) samples based on an initial estimate [symbol] from a previous (k−1)^{th} iteration of the third iterative process; determining, for each estimated quadrature component value \hat{Q}(t_{i,k-1}) of the \hat{Q}(tₖ₋₁) values, a corresponding quadrature component estimation error y_{Q}(t_{i,k}) between (i) the respective estimated quadrature component value \hat{Q}(t_{i,k-1}) and (ii) the respective quadrature component sample Q(tᵢ), thereby obtaining n quadrature component estimation errors (y_{Q}(tₖ) estimation errors); solving a third set of matrix equations based on the y_{Q}(tⱼ) estimation errors, thereby obtaining an updated estimate [symbol] for the k^{th} iteration. In accordance with a determination that the number of iterations k satisfies a sixth threshold value, the method includes, in accordance with a determination that a change in value of one or more predetermined second parameters between the k^{th} iteration and the (k−1)^{th} iteration satisfies a respective corresponding threshold: determining that the third iterative process has converged; outputting the updated estimate [symbol] as the solution for A_{Q}; and terminating the third iterative process. The method includes, in accordance with a determination that the change in value of the one or more predetermined second parameters between the k^{th} iteration and the (k−1)^{th} iteration does not satisfy a respective corresponding threshold, performing a next iteration of the third iterative process. The method includes, in accordance with the determination that (i) the number of iterations k does not satisfy the sixth threshold value, terminating the third iterative process without producing a solution for A_{Q}.

In some embodiments, the method includes computing the carrier phase multipath error ϕe based on the solutions for A_{I} and A_{Q}; correcting the pseudorange measurement for the respective satellite in accordance with Δt; and correcting the carrier phase measurement for the respective satellite in accordance with the carrier phase multipath error ϕ_{ε}.

In some embodiments, the method includes, in accordance with the determination that the phase ϕ_{3rd} corresponds to ±90° within the first predefined margin: using the initial estimates [symbol] , [symbol] , and [symbol] as starting values, obtaining a solution for A_{Q}, Aₘ, and δ via a fourth iterative process, wherein k is a positive integer representing a number of iterations of the fourth iterative process. A k^{th} iteration of the fourth iterative process includes: obtaining n estimated quadrature component values (\hat{Q}(tₖ₋₁) values) for the Q(t) samples based on initial estimates [symbol] , [symbol] , and [symbol] from a previous (k−1)^{th} iteration of the fourth iterative process; determining, for each estimated quadrature component value \hat{Q}(t_{i,k-1}) of the \hat{Q}(tₖ₋₁) values, a respective quadrature component estimation error y_{Q}(t_{i,k}) between (i) the respective estimated quadrature component value \hat{Q}(t_{i,k-1}) and (ii) the respective quadrature component sample Q(tᵢ), thereby obtaining n quadrature component estimation errors (y_{Q}(tₖ) estimation errors); and solving a fourth set of matrix equations based on the y_{Q}(tₖ) estimation errors, thereby obtaining updated estimates [symbol] , [symbol] , and [symbol] for the k^{th} iteration. The method includes, in accordance with a determination that (i) the updated estimate [symbol] is within a corresponding third valid range and (ii) the updated estimate [symbol] is within a corresponding fourth valid range: in accordance with a determination that the number of iterations k satisfies a seventh threshold value: in accordance with a determination that a change in value of one or more predetermined second parameters between the k^{th} iteration and the (k−1)^{th} iteration satisfies a respective corresponding threshold: determining that the fourth iterative process has converged; outputting the updated estimates [symbol] , [symbol] , and [symbol] as the solution for A_{Q}, Aₘ, and δ, respectively; and terminating the fourth iterative process. The method includes, in accordance with the determination that the change in value of the one or more predetermined parameters between the k^{th} iteration and the (k−1)^{th} iteration does not satisfy the respective corresponding threshold, performing a next iteration of the fourth iterative process. The method includes, in accordance with the determination that (i) the number of iterations k does not satisfy the seventh threshold value, terminating the fourth iterative process without producing a solution for A_{Q}.

In some embodiments, the method includes, in accordance with a determination that (i) the updated estimate [symbol] is not within a corresponding third valid range or (ii) the updated estimate [symbol] is not within a corresponding fourth valid range: updating the initial estimate for the time delay δ from [symbol] to [symbol] ; and executing the fourth iterative process using the initial estimates [symbol] and [symbol] and the updated initial estimate [symbol] as the starting values.

In some embodiments, the method includes using the initial estimates [symbol] and [symbol] and the adjusted initial estimate [symbol] as the starting values. The method includes, in accordance with a determination that (i) the updated estimate [symbol] is not within the corresponding third valid range or (ii) the updated estimate [symbol] is not within the corresponding fourth valid range: in accordance with a determination that a next adjusted value for the time delay would fall within a range of time values for the n pairs of correlation samples, repeating the steps of updating the initial estimate for the time delay δ and executing the fourth iterative process; and otherwise, outputting information that no valid solution for A_{Q}, Aₘ, and δ has been determined.

In some embodiments, the method includes, in conjunction with outputting the updated estimates [symbol] , [symbol] , and [symbol] as the solution for A_{Q}, Aₘ, and δ, respectively: obtaining a solution for A_{I} by solving a matrix equation

$$[ \begin{matrix}SR ( {t}_{1} ) \\ SR ( {t}_{2} ) \\ ⋮ \\ SR ( {t}_{n} )\end{matrix} ] {A}_{I} = [ \begin{matrix}I ( {t}_{1} ) \\ I ( {t}_{2} ) \\ ⋮ \\ I ( {t}_{n} )\end{matrix} ] .$$

In some embodiments, the method includes computing the carrier phase multipath error ϕ_{ε} based on the solution for A_{I} and the solution for Aₘ; and correcting the carrier phase measurement for the respective satellite in accordance with the carrier phase multipath error ϕ_{ε}.

In accordance with some embodiments, a navigation module, or a global navigation satellite system (GNSS) receiver, or a device for mitigating the effect of a multipath-induced error in a global navigation satellite system (GNSS) includes one or more processors and memory. The memory stores instructions that, when executed by the one or more processors, cause the navigation module, or GNSS receiver, or device, to perform any of the methods disclosed herein.

In accordance with some embodiments, a computer-readable storage medium is provided that stores instructions which, when executed by a navigation module, or a global navigation satellite system (GNSS) receiver, or a device, that includes one or more processors, cause the navigation module, or the GNSS receiver, or the device, to perform the any of the methods described herein.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a navigation system, according to some embodiments.

FIG. 1B illustrates a block diagram of a GNSS receiver in accordance with some embodiments.

FIG. 1C is a block diagram of a computer system, such as a computer system that is part of a moveable object's navigation system, according to some embodiments.

FIG. 2 illustrates a block diagram of a baseband DSP channel in accordance with some embodiments.

FIG. 3 illustrates an example where both a direct-path signal and a multipath signal from a satellite are received by an antenna of a GNSS receiver, in accordance with some embodiments.

FIG. 4A illustrates a phasor diagram of the in-phase and quadrature components of a direct-path signal, in accordance with some embodiments. FIG. 4B illustrates a phasor diagram of the in-phase and quadrature components of a composite signal, which is composed of a direct-path signal and a multipath signal, in accordance with some embodiments.

FIG. 5 illustrates the magnitude of a filter step response function SR(t) versus time, in accordance with some embodiments.

FIG. 6 illustrates a correlator arrangement in which 16 pairs of samples are arranged along a code chip transition, and a delayed version of the filter step response function SR(t−δ), in accordance with some embodiments.

FIGS. 7A and 7B are phasor diagrams illustrating multipath scenarios where angle ϕ_{3rd} is equal to +90° and −90°, respectively, in accordance with some embodiments.

FIGS. 8A and 8B are phasor diagrams illustrating multipath scenarios where angle ϕ_{3rd} is equal to 0° and 180°, respectively, in accordance with some embodiments.

FIG. 9 is a workflow for Procedure 1 of the phase multipath mitigation algorithm, in accordance with some embodiments

FIGS. 10A and 10B show an example of I(tᵢ) measurement samples when angle ϕ_{3rd} is equal to 0° and 180°, respectively, in accordance with some embodiments.

FIG. 11 illustrates a workflow 1100 for Procedure 2 of the phase multipath mitigation algorithm, in accordance with some embodiments.

FIG. 12 illustrates a workflow for solving the unknown parameters, A_{I}, A_{Q}, Aₘ, and δ when ϕ_{3rd} is not ±90°, in accordance with some embodiments.

FIG. 13 illustrates a workflow for solving for the unknown parameters A_{I}, A_{Q}, Aₘ, and δ when ϕ_{3rd} is equal to ±90°, in accordance with some embodiments.

FIG. 14 illustrates a series of different initial estimates [symbol] that can be tried sequentially, in accordance with some embodiments.

FIG. 15A illustrates a phasor diagram for a very weak multipath scenario with ϕ_{3rd}=30°. FIG. 15B illustrates a correct solution to angle ϕ_{ε} even when this multipath scenario is detected as a case of ϕ_{3rd}=+90°.

FIGS. 16A and 16B illustrate a flowchart diagram for a method of mitigating the effect of a multipath-induced error in a GNSS, in accordance with some embodiments.

### DESCRIPTION OF EMBODIMENTS

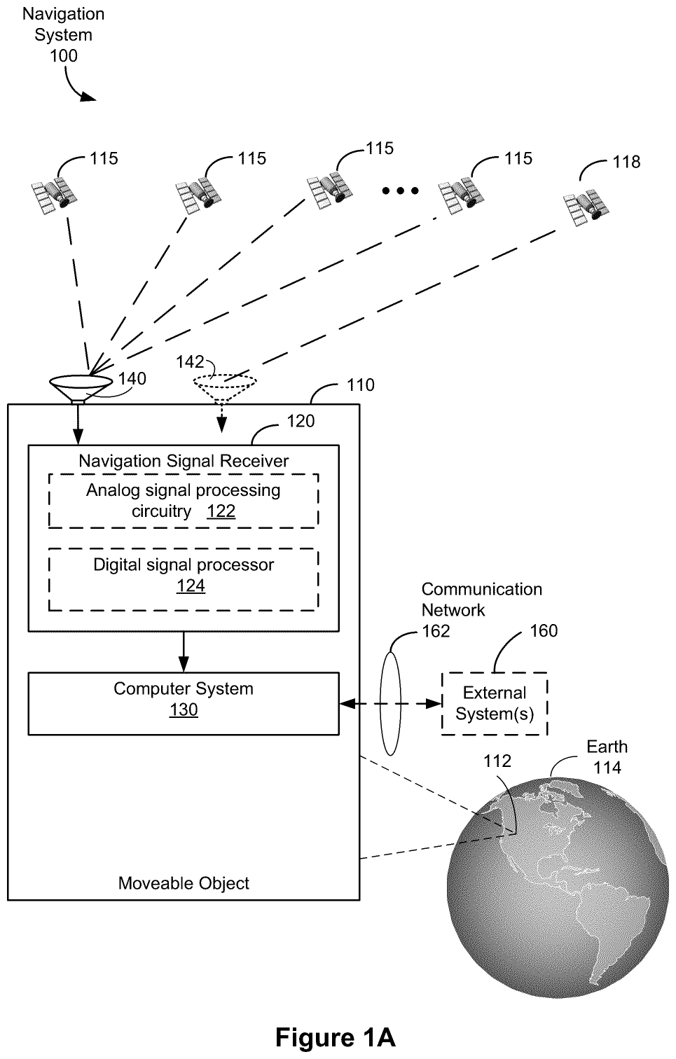

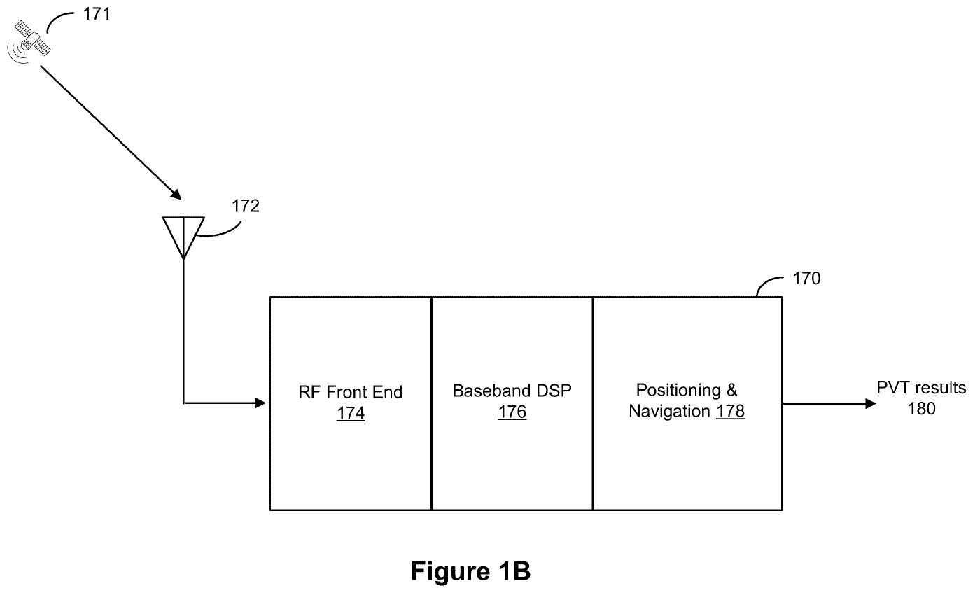

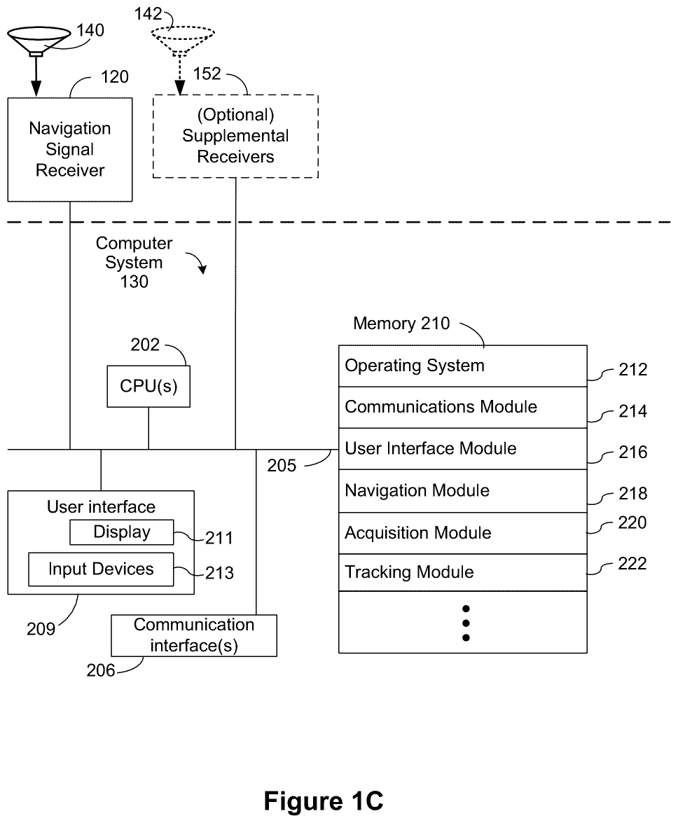

FIG. 1A is a block diagram illustrating a navigation system 100, according to some embodiments. Navigation system 100 enables a moveable object 110 (e.g., a phone, specialized GNSS receiver, a boat, a truck or other vehicle, a farming appliance, mining appliance, drilling system, etc.) to determine, at any point of time, its current position 112 with respect to a global coordinate system (e.g., a coordinate system for Earth 114). Moveable object 110 is equipped with a satellite receiver (navigation signal receiver 120), typically including or coupled to one or more satellite antennas 140, to receive satellite navigation signals from at least four satellites 115 that are orbiting Earth. The satellite navigation signals received by moveable object 110 are typically global navigation satellite system (GNSS) signals.

Moveable object 110 optionally receives satellite orbit correction information and satellite clock correction information (sometimes collectively called “correction information”) for the plurality of satellites. The correction information is typically broadcast by and received from one or more satellites 118 distinct from the GNSS satellites 115, using an antenna 142 and signal receiver 152 (see FIG. 1C) distinct from antenna 140 and navigation signal receiver 120 used to receive the satellite navigation signals. However, in some embodiments, the same antenna and receiver are used to receive both satellite navigation signals and correction information

Moveable object 110 determines a position of moveable object 110, using the received satellite navigation signals and, optionally, the received satellite orbit correction information and satellite clock correction information for the plurality of satellites. In some embodiments, received satellite navigation signals are processed by navigation signal receiver 120, including analog signal processing circuitry 122 and a digital signal processor 124, optionally taking into account the correction information, to determine code measurements and phase measurements for signals received from four or more satellites 115. Embedded computer system 130 determines the position of moveable object 110 based on those measurements.

FIG. 1B illustrates a block diagram of an example GNSS receiver 170 (e.g., navigation signal receiver 120) in accordance with some embodiments. The GNSS receiver 170 receives signals from one or more GNSS satellites (e.g., GNSS satellite 171), processes the signals, and delivers Position, Velocity and Time (PVT) results 180. In some embodiments, the GNSS receiver 170 includes an antenna 172, a radio frequency (RF) front end module 174, a baseband digital signal processing (DSP) module 176, and a positioning and navigation module 178. The antenna 172 is the first stage of the GNSS receiver 170 and receives RF signals from all visible GNSS satellites. In some embodiments, the antenna 172 is equipped with a built-in amplifier. In some embodiments, the GNSS receiver 170 is equipped with multiple antennas or an antenna array. The received RF signals are filtered, amplified, down-converted, and digitized by the RF front end module 174. The RF front end module 174 typically includes one or more stages of down-conversions and filters, to convert the RF signals to different intermediate frequency (IF) bands with designated bandwidths while excluding out-of-band interferences. The final filter in high-precision GNSS receivers typically has a wide bandwidth (e.g., 30 MHz or more). One important characteristic of the final filter of the RF front end module 174 is its step response, which will be described later. Analog-to-digital (A/D) converters in the RF front end module convert received analog signals, e.g., from the final filter, into digital Intermediate Frequency (IF) signals. In some embodiments, the RF front end electronics 174 are integrated into a RF Application-Specific Integrated Circuit (ASIC) chip.

The RF front end module 174 outputs digital IF signals, which are processed by the baseband DSP module 176. By processing the digital IF signals, the baseband DSP module 176 acquires and tracks each individual visible satellite (e.g., each satellite for which there is a direct line of sight to the receiver 170), generates range measurements, including code phase measurements (and therefore pseudorange measurements), carrier phase measurements and doppler measurements, and decodes navigation data bits encoded in the signal(s) received from each satellite. According to some embodiments of the present disclosure, phase multipath mitigation is performed by the baseband DSP module 176. In some embodiments, the baseband DSP module 176 comprises both hardware and firmware, but the division of these two portions is often not clearly defined and depends on a variety of design considerations. In some embodiments, the baseband DSP electronics are integrated into a baseband ASIC chip. In some embodiments, the RF front-end electronics and the baseband DSP electronics are integrated into a single-die System-On-Chip (SOC) chip.

The baseband DSP module 176 outputs range measurements and navigation data that are used by the positioning and navigation module 178 to calculate PVT results 180. In some embodiments, the PVT results 180 are used by user applications. In some embodiments, the positioning and navigation module 178 is implemented in software executed by a microprocessor, while the firmware portion of the baseband DSP module 176 is implemented in either the same microprocessor as the microprocessor of the positioning and navigation module 178, or in a separate microprocessor. In some embodiments, the GNSS receiver 170 includes more than one microprocessor.

FIG. 1C is a block diagram of computer system 130 in, and used by, a moveable object (e.g., moveable object 110, FIG. 1A) to determine the position of the moveable object, according to some embodiments.

Computer system 130 typically includes one or more processors (sometimes called CPUs, or hardware processors) 202 for executing programs or instructions; memory 210; one or more communications interfaces 206; and one or more communication buses 205 for interconnecting these components. Computer system 130 optionally includes a user interface 209 comprising a display device 211 and one or more input devices 213 (e.g., one or more of a keyboard, mouse, touch screen, keypad, etc.) coupled to other components of computer system 130 by the one or more communication buses 205. Navigation signal receiver 120 (or GNSS receiver 170), and supplemental receiver(s) 152, if provided, are also coupled to other components of computer system 130 by the one or more communication buses 205. The one or more communication buses 205 may include circuitry (sometimes called a chipset) that interconnects and controls communications between system components.

Communication interface 206 (e.g., a receiver or transceiver) is used by computer system 130, and more generally moveable object 110, to convey information to external systems (e.g., external system(s) 160, FIG. 1A), and to receive communications from external systems.

Memory 210 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 210 optionally includes one or more storage devices remotely located from the CPU(s) 202. Memory 210, or alternately the non-volatile memory device(s) within memory 210, comprises a computer readable storage medium (e.g., a non-transitory computer readable storage medium). In some embodiments, memory 210 or the computer readable storage medium of memory 210 stores the following programs, modules and data structures, or a subset thereof:
an operating system 212 that includes procedures for handling various basic system services and for performing hardware dependent tasks;
a communications module 214 that operates in conjunction with communication interface 206 (e.g., a receiver and/or transceiver) to handle communications between moveable object 110 and external systems 160 (FIG. 1); the connection between computer system 130 and external systems 160 may include a communication network 162, such as the internet or a public or proprietary wireless network;
optionally, a user interface module 216 for receiving information from one or more input device 213 of user interface 209, and to convey information to a user of moveable object 110 via one or more display or output devices 211;
a navigation module 218 for determining a position of the moveable object and performing one or more navigation functions (e.g., routing of the mobile object; displaying on a map one or more suggested routes for moving the mobile object from a current location to a specified or target location; and/or providing information regarding locations nearby the mobile object or along a proposed route of the mobile object);
an acquisition engine 220 for acquiring satellite signals from GNSS satellites, including determining a tracking frequency and a code shift (sometimes called a code offset) for each of several respective GNSS satellites, or for managing operation of an acquisition engine that is implemented, at least in part, in digital signal processor 124; and
a tracking module 222, sometimes called the satellite signal tracking module, which tracks GNSS satellite signals using acquisition information (e.g., the tracking frequency and code shift) handed over from the acquisition module 220, or for managing operation of a tracking module that is implemented, at least in part, in digital signal processor 124. For example, in some embodiments, tracking module 222 samples a GNSS satellite signal using a tracking frequency and code shift initially determined by the acquisition module 220, and then adjusted by the tracking module itself as the tracking module determines code phase corrections for respective channels of the received satellite navigation signals.

Operating system 212 and each of the above identified modules and applications correspond to a set of instructions for performing a function described above. The set of instructions can be executed by the one or more processors 202 of computer system 130. The above identified modules, applications or programs (i.e., sets of instructions) need not be implemented as separate software programs, procedures or modules, and thus various subsets of these modules may be combined or otherwise re-arranged in various embodiments. In some embodiments, memory 210 stores a subset of the modules and data structures identified above. Furthermore, memory 210 optionally stores additional modules and data structures not described above.

FIG. 1C is intended more as a functional description of the various features which may be present in a computer system 130 of a moveable object 110 than as a structural schematic of the embodiments described herein. In practice, and as recognized by those of ordinary skill in the art, items shown separately could be combined and some items could be separated. For example, some items shown separately in FIG. 1C could be combined into a single module or component, and single items could be implemented using two or more modules or components. The actual number of modules and components, and how features are allocated among them will vary from one implementation to another.

In addition, in some embodiments, some or all of the above-described functions may be implemented with hardware circuits (e.g., which may comprise graphics processors for efficiently performing discrete Fourier transforms (DFTs), field programmable gate arrays (FPGAs), application specific integrated circuits (ASICs), a “system on a chip” that includes processors and memory, or the like). To that end, in some embodiments, CPUs 202 include specialized hardware for performing these and other tasks. In some embodiments, some of the operations described above with respect to computer system 130 are performed by navigation signal receiver 120 and/or GNSS receiver 170 rather than computer system 130.

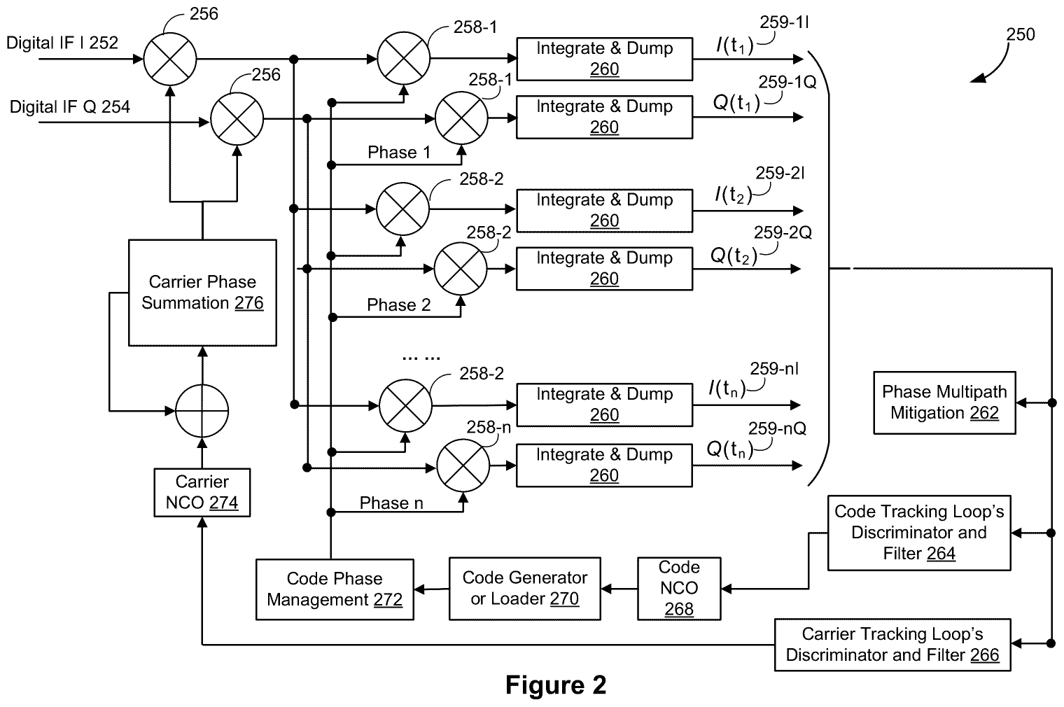

In some embodiments, the baseband DSP module 176 processes digital IF signals channel by channel (e.g., one channel per satellite being tracked). FIG. 2 illustrates a block diagram of a baseband DSP channel 250 in accordance with some embodiments. Each channel may include hardware and software components configured to acquire and track one code signal of one satellite. In some multi-constellation, multi-frequency receivers, there can be tens or hundreds of nearly identical channels running and sharing the baseband DSP hardware resources, for example using time multiplexing.

The baseband DSP module 176 receives (e.g., fetches) digital in-phase (I) IF samples 252 and quadrature (Q) IF samples 254 from the RF front-end module 174 of the GNSS receiver 170. The digital I IF samples 252 and Q IF samples 254 are first mixed with the replicas of the carrier signal in carrier removal mixers 256, so the carrier frequency of the received signals is stripped off, and the digital IF signals are down-converted to baseband I and Q samples, respectively. To completely strip off the carrier frequency, including doppler shift of the carrier frequency, the receiver generated carrier signal is synchronized with the frequency of the received IF signals. Maintaining carrier frequency synchronization is a primary goal of the carrier tracking loop in each channel of the receiver. Furthermore, when the carrier tracking loop of a DSP channel 250 is configured to align the phase of the receiver generated carrier signal with the carrier phase of the received IF signals, the carrier tracking loop is called a phase lock loop or phase-locked loop (PLL).

The I and Q signals output by the carrier removal mixers 256 are then correlated with n replicas of code (e.g., the pseudorandom code corresponding to the satellite for which IF signals are being processed, provided by code phase management unit 272) in n pairs of correlators 258 (e.g., correlator pair 258-1, correlator pair 258-2, . . . and correlator pair 258-n). Controlled by code phase management unit 272, each of the n replicas of the code has a different phase delay. Typically, the code phase of one of the n replicas is better aligned with the code phase of the received signals than any of the other replicas, and the correlation of that replica with the received signals has a peak value relative to the other correlations. The strongest correlation is identified and used by the code tracking loop's discriminator and filter 264, and the carrier tracking loop's discriminator and filter 266, to adjust the code tracking loop and carrier tracking loop, and to remove the code (sometimes called a spreading spectrum code) from the received I and Q samples. After the received signals are de-spread by the correlators 258, the resulting signals represent the navigation data bits or symbols that are encoded (e.g., embedded) in the received satellite signal. Controlled by code phase management unit 272, each of the n replicas of the code has a different phase delay. Typically, the code phase of one of the n replicas is aligned with the code phase of the received signals, therefore their correlation can achieve a peak value. The goal of Code Tracking Loop in the receiver is to maintain this code phase synchronization or code phase lock.

All 2n correlation results are coherently integrated for a pre-detection integration time in integrate and dump circuits 260, and then dumped for further signal detection tracking and/or multipath mitigation (e.g., via phase multipath mitigation unit 262), etc. The length of the pre-detection integration (PDI) time depends on the received signal's navigation data bit rate or symbol rate and other design considerations. A typical value of the PDI is 1 ms. The n pairs of coherent integration I and Q samples are denoted as/(t₁) 259-1I and Q(t₁) 259-1Q, I(t₂) 259-2I and Q(t₂) 259-2Q, . . . , and/(tₙ) 259-nI and Q(tₙ) 259-nQ. The coherent integration samples can be further coherently or non-coherently integrated for a longer duration in a receiver to achieve a higher signal to noise ratio (SNR).

In some embodiments, a conventional design generates three replicas of code (n=3), called Early, Prompt and Late, indicating their code phases relative to the code phase of the received signals, and thus this design obtains three samples of the signal's auto-correlation function (ACF). Based on the Early, Prompt and Late correlation results, the code tracking loop's discriminator and filter 264 can identify the code phase difference between the received signals and the Prompt replica of the code, filter it, and use it to adjust and drive code numerically controlled oscillator (NCO) 268. The output of the code NCO 268 is used by code generator or loader 270 to control the frequency and phase of the Prompt code replica such that it is kept aligned with those of the received signals. Based on the phase of the Prompt code, the code tracking loop's discriminator and filter 264 can generate code phase measurements of the received signals. Using time information obtained by combining information obtained from the satellite signals of four or more satellites, the code phase measurements are used to generate pseudorange measurements, which are one type of key satellite range measurement for GNSS positioning (e.g., determining the position of a mobile object, such as mobile object 110, FIG. 1A).

Meanwhile, the carrier tracking loop's discriminator and filter 266 typically utilizes only the pair of Prompt correlations, discriminates the frequency difference and/or phase difference between the received signals and the receiver generated carrier signal, filters the difference(s), and drives carrier NCO 274 so as to maintain synchronization between the received signals (e.g., from the satellite being tracked by the baseband DSP channel 250) and the carrier signal replica produced by carrier NCO 274 and carrier phase summation unit 276. In addition to carrier phase measurements, which is another type of key satellite range measurement for GNSS positioning, the carrier tracking loop's discriminator and filter 266 can also output raw navigation data bits or symbols embedded in the satellite signal being processed by the baseband DSP channel 250.

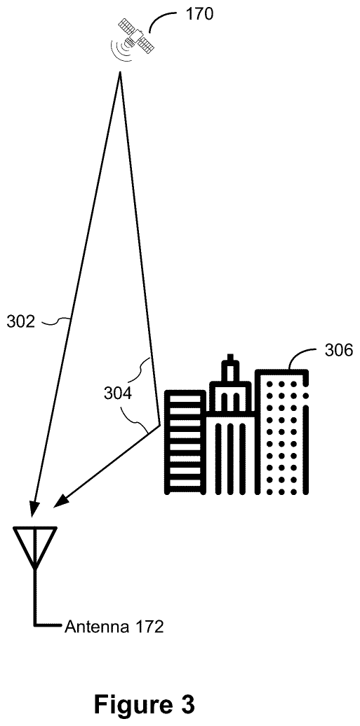

FIG. 3 illustrates an example where both a direct-path signal 302 and a multipath signal 304 from a satellite 170 are received by an antenna 172 of a GNSS receiver. GNSS signals from satellites-whether line-of-sight (LOS) direct-path signals or multipath signals—that enter a receiver's antenna will all be processed by the receiver. When a direct-path signal is reflected by surroundings, such as buildings 306, or mountains, or lakes, and/or other objects, it is called a multipath (or multipath signal).

In some embodiments, a composite signal s (t) of a direct-path signal and its multipath signal can be mathematically modeled as:

$$s ( t ) = {A}_{d} sin ( ω t ) + {A}_{m} sin ( ω ( t - δ ) + ϕ ) \qquad ( 1 )$$

where t represents the time that the composite signal is sampled or measured, A_{d} is an amplitude of the direct-path signal 302, Aₘ is an amplitude of the multipath signal 304, δ is a time delay of the multipath signal 304 relative to the direct-path signal 302 (δ is also referred to as “multipath time delay”), and ϕ is a phase delay of the multipath signal 304 relative to the direct-path signal 302 (ϕ is also referred to as “multipath phase delay”). Since the path-length of a multipath signal 304 is always longer than that of the corresponding direct-path signal 302, the time delay δ is always larger than zero. The multipath signal amplitude Aₘ is typically smaller than the direct-path signal amplitude A_{d}. The multipath phase delay ϕ can be any value ranging from −180° to 180°. When ϕ is equal to 0°, the multipath signal is in-phase with the direct-path signal. When ϕ is equal to 180°, the multipath signal is out-of-phase with the direct-path signal. In some embodiments, Aₘ, δ, and ϕ are the three independent parameters that describe a multipath signal.

The composite signal model in equation 1 assumes that a direct-path signal always exists, i.e., A_{d} is always larger than 0. If the direct-path signal is blocked (e.g., by trees or buildings), corresponding multipath signals, if any, may be detected and excluded by the GNSS receiver using multipath mitigation mechanisms different from those described in this document. Equation 1 also assumes that there is at most one multipath signal for each direct-path signal. If more than one multipath signal exists, it is assumed that the strongest multipath signal is a dominant signal that is much stronger than all the remaining multipath signals such that all the remaining multipath signals can be omitted or ignored for purposes of mitigating multipath-induced errors in GNSS receiver positioning.

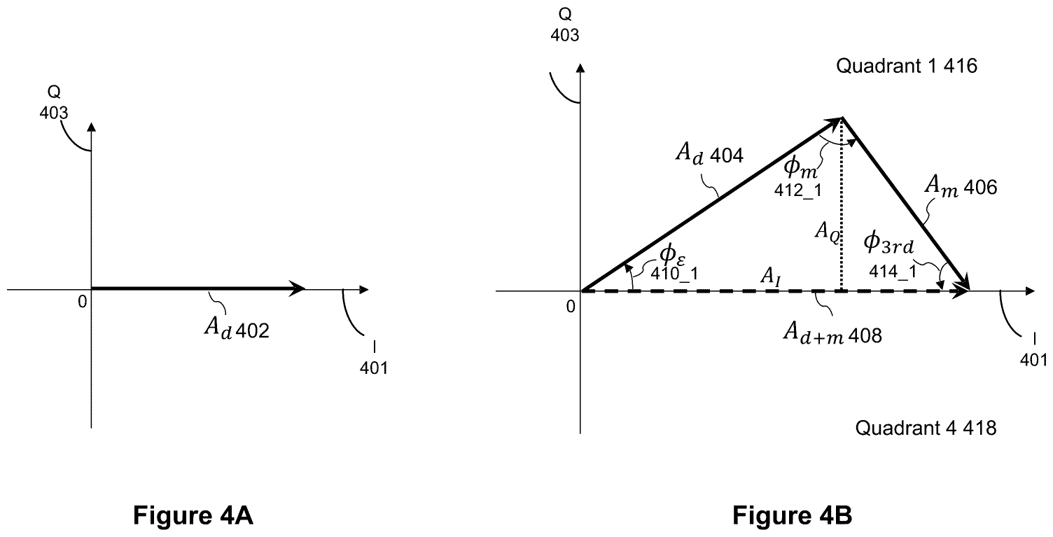

FIG. 4A illustrates a phasor diagram of the in-phase (I) and quadrature (Q) components of a direct-path signal in accordance with some embodiments. FIG. 4A shows that this phasor vector is aligned with the I axis, i.e., the value of Q component is equal to 0, and the magnitude of the vector, A_{d} 402, is equal to the value of I component. This pair of I and Q samples is just one of the n pairs of coherent integration I and Q samples as shown in FIG. 2. As described above, the carrier tracking loop utilizes this pair of I and Q samples to make the phase of the generated carrier signal phase-locked with that of the received signal by driving Q component to zero. In other words, FIG. 4A is a phasor diagram when the carrier tracking loop is in a steady state of phase lock. The vector magnitude A_{d} 402 may not be numerically equal to the direct-path signal magnitude A_{d} in equation 1 due to receiver signal processing; however, they only differ by a scale factor since the receiver signal processing can be regarded as a linear system.

When a direct-path signal 302 and a multipath signal 304 are both received and processed by a receiver, multipath errors can be introduced to range measurements, for example, pseudorange and carrier phase measurements. FIG. 4B illustrates a phasor diagram of I (401) and Q (403) components of a composite signal, i.e., a direct-path signal plus a multipath signal, where A_{d} 404 is the magnitude of the direct-path signal phasor vector, Aₘ 406 is the magnitude of the multipath signal phasor vector, and A_{d+m} 408 is the magnitude of the composite signal phasor vector. When the composite signal is processed by a receiver, the resulted coherent integration I and Q samples are the linear sum of integration values from the direct-path signal and integration values from the multipath signal, corresponding to the sum of the two vectors in the phasor diagram. Thus, at the steady state of a PLL, the summation vector, represented by the dashed line of the composite signal phasor vector, is aligned with (e.g., parallel to) the I axis. However, if the multipath signal does not exist, the direct-path signal phasor vector would be aligned with the I axis instead, just as shown in FIG. 4A. Therefore, the angle, ϕ_{ε} 410 between the summation vector and the direct-path signal vector is the carrier phase multipath error introduced by the multipath signal. An objective of methods and systems disclosed herein is to estimate the carrier phase multipath error ϕ_{ε} 410, and correct and mitigate multipath errors in the corresponding carrier phase measurement for the respective satellite in accordance with the carrier phase multipath error ϕ_{ε} 410.

FIG. 4B shows that the direct-path signal phasor vector, the multipath signal phasor vector, and the composite signal phasor vector form a triangle. Phase difference angle ϕₘ 412 between the direct-path signal vector and the multipath signal vector is supplementary to the multipath phase delay ϕ as defined in equation 1. Angle ϕ_{3rd} 414 is the third angle of the triangle, so the sum of carrier phase multipath error ϕ_{ε} 410, the phase difference angle ϕₘ 412, and the third angle ϕ_{3rd} 414 is equal to 180°, and therefore phase difference angle ϕₘ 412 is equal to 180° minus the sum of the other two angles:

$${ϕ}_{m} = 180 ° - {ϕ}_{3 rd} - {ϕ}_{ε} \qquad ( 2 )$$

If the triangle lies in the first quadrant (i.e., in Quadrant 1 416) of this I-Q phasor coordinate system, then all the three angles ϕ_{ε} 410, ϕₘ412, and ϕ_{3rd} 414, are defined to be positive; otherwise, if the triangle lies in the fourth quadrant (i.e., in Quadrant 4 418), then all three angles are defined to be negative.

Based on the geometry in FIG. 4B, the following relationships among all these parameters are obtained:

$$I = {A}_{d} cos {ϕ}_{ε} + {A}_{m} cos {ϕ}_{3 rd} \\ Q = {A}_{d} sin {ϕ}_{ε} - {A}_{m} sin {ϕ}_{3 rd} \qquad ( 3 )$$

As explained above, coherent integration Q is zero ideally at the steady state of a phase lock loop if noise does not exist, in which case:

$${A}_{d} sin {ϕ}_{ε} = {A}_{m} sin {ϕ}_{3 rd} \qquad ( 4 )$$

Meanwhile, from the geometry in FIG. 4B, the following relationship can also be obtained:

$${A}_{d + m} = {A}_{d} cos {ϕ}_{ε} + {A}_{m} cos {ϕ}_{3 rd} \qquad ( 5 )$$

Equation 3 does not contain the multipath time delay δ, since it assumes that I and Q integration samples are taken when the values of the direct-path signal and the multipath signal both have reached their amplitudes A_{d} and Aₘ, respectively. When I and Q samples are taken at code chip edge-up or edge-down transitions, equation 3 needs to be changed into the following form:

$$I ( t ) = {A}_{d} SR ( t ) cos {ϕ}_{ε} + {A}_{m} SR ( t - δ ) cos {ϕ}_{3 rd} \\ Q ( t ) = {A}_{d} SR ( t ) sin {ϕ}_{ε} - {A}_{m} SR ( t - δ ) sin {ϕ}_{3 rd} \qquad ( 6 )$$

where SR(t) is the magnitude step response of the last stage band pass filter in a receiver's RF front end 174. Equation 6 contains both the step response SR(t) and its delayed version SR(t−δ), and, as discussed below, can be used to estimate the multipath parameters (e.g., Aₘ, δ, and/or ϕ).

In general, a GNSS signal is a sinusoidal carrier signal modulated at least by some code, where the code is a pseudo random sequence of ones and zeros, which are called chips. The signal carrier phase will undergo a 180° phase reversal at a code chip edge transition, either from 0 to 1 or from 1 to 0. For example, GPS L1 Coarse Acquisition (CA) signal has a center carrier frequency of 1575.42 MHz, and its CA code has a chipping rate of 1.023 MHz. Thus, if the baseband DSP 176 carries on correlation and integration for a PDI period of 1 ms, a received GPS L1 CA signal would be expected to have about 1023 code chip edge transitions during each PDI period of 1 ms.

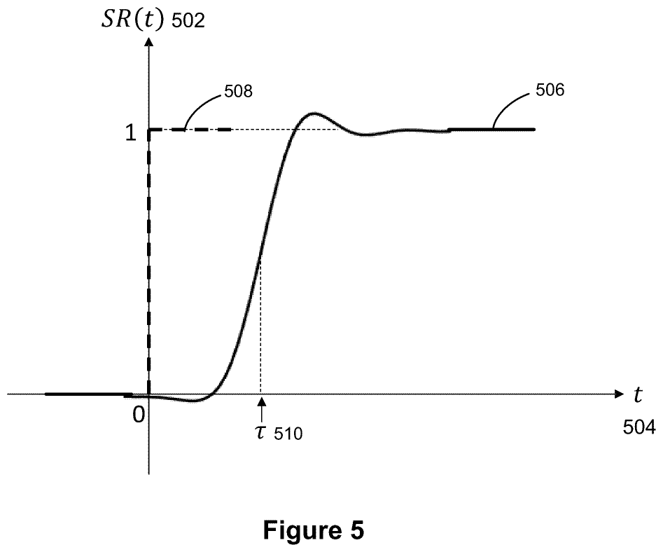

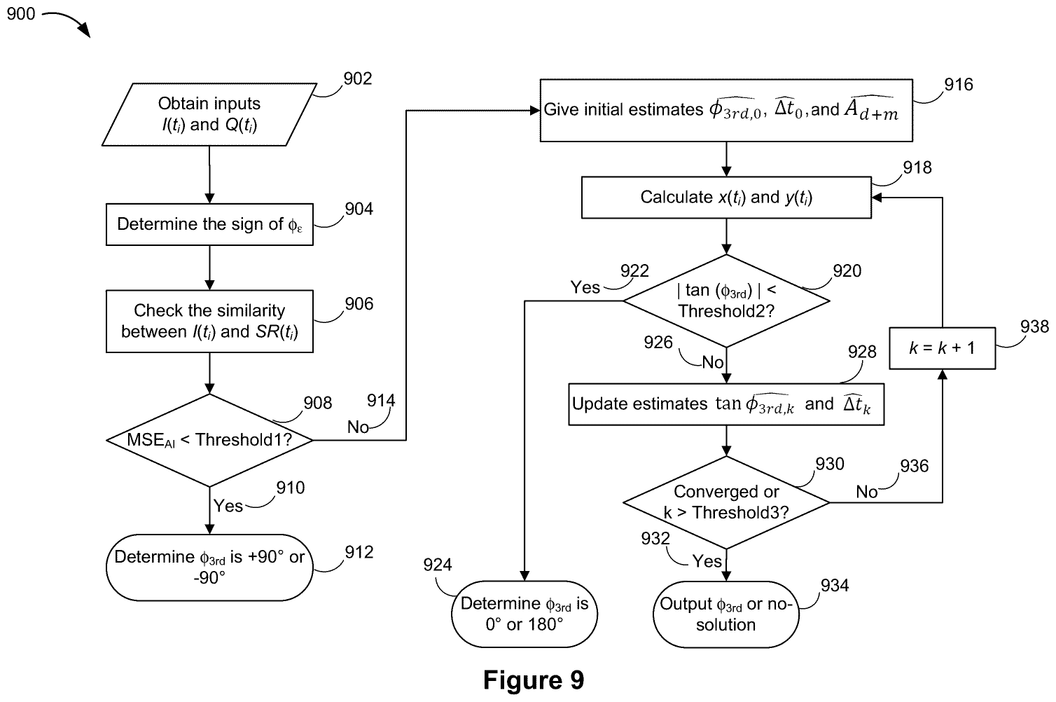

FIG. 5 illustrates an example of the magnitude 502 of a filter step response function SR(t) versus time, in accordance with some embodiments. The dashed line 508 represents an ideal code chip edge-up transition from 0 to 1 instantaneously at time 0. However, because of the RF front end filtering, or equivalently, because the received signal is filtered and thus bandwidth limited, it is impossible to have such an ideal transition which contains infinitely high frequency components in practice. The solid line 506 represents an example of the actual magnitude of the filter step response function SR(t) versus time, where a code chip edge-up transition serves as a step input function. Compared to the corresponding ideal step response (represented by the dashed line 508), the actual step response SR(t) shown by the solid line 506 not only has a response time of τ 510 but also has some overshoots before and after the transition. These step response characteristics are determined by the type and bandwidth of the final filter in the receiver's RF front end module 174. For example, a 6-pole Butterworth filter with an IF equivalent bandwidth of 30 MHz has a step response time of about 50 ns and enters steady state after about 150 ns. The code chip edge transition step response model SR(t) is determined and stored in memory of the receiver before the phase multipath mitigation algorithm (e.g., as described in FIGS. 9, 11, 12, and 13) is executed.

In some embodiments, the baseband DSP module 176 of a GNSS receiver outputs I and Q samples along code chip edge transitions. When a satellite signal is tracked and locked, code phase management unit 272 can properly control and set the phase delays of n pairs of code replicas in such a way that the corresponding n pairs of correlation results, I(t₁) 259-1I and Q(t₁) 259-1Q,/(t₂) 259-2I and Q(t₂) 259-2Q, . . . , and/(tₙ) 259-nI and Q(tₙ) 259-nQ, are along code chip edge transitions. The i^{th} pair of I and Q samples can be rewritten as

$$I ( {t}_{i} ) = {A}_{d} SR ( t ) cos {ϕ}_{ε} + {A}_{m} SR ( t - δ ) cos {ϕ}_{3 rd} \\ Q ( {t}_{i} ) = {A}_{d} SR ( t ) sin {ϕ}_{ε} - {A}_{m} SR ( t - δ ) sin {ϕ}_{3 rd} \qquad ( 7 )$$

where i=1, 2, . . . , n.

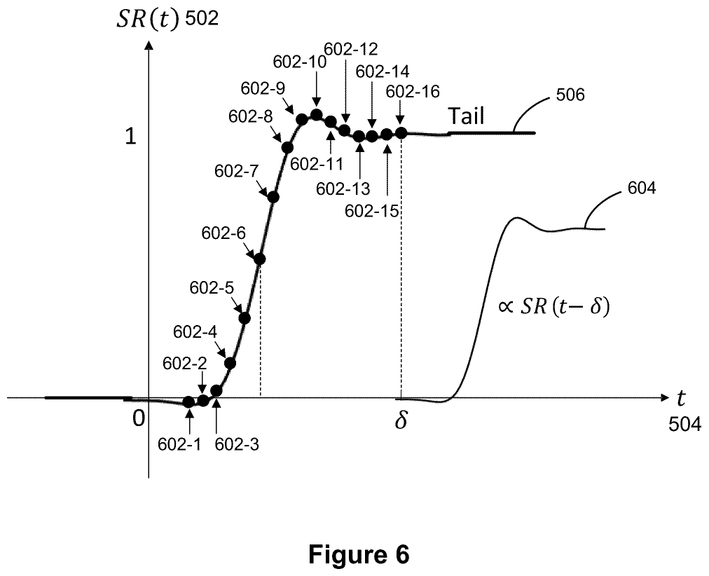

FIG. 6 illustrates a correlator arrangement in which 16 pairs of samples 602-i (i=1 to 16 in this example) are arranged (e.g., uniformly) along a code chip transition, and a delayed version of the filter step response function SR(t−δ) 604. In some embodiments, the correlation measurements/(tᵢ) and Q(tᵢ) are the summed, or equivalently, averaged ones over all code chip edge transitions in one period of correlation duration. In some embodiments, only a subset of all these n pairs of correlators are arranged along code chip edge transitions for the purpose of phase multipath mitigation. In some embodiments, the effective correlators for the purpose of phase multipath mitigation are constructed in a different approach, for example, by utilizing multiple channel resources. In some embodiments, the number of pairs of correlation samples can be increased to cover a larger portion (e.g., even covering a tail portion) of the PN code sequence so as to accurately measure even long delayed multipath signals. Optionally, enough correlators are arranged to cover a entire code chip edge transition.

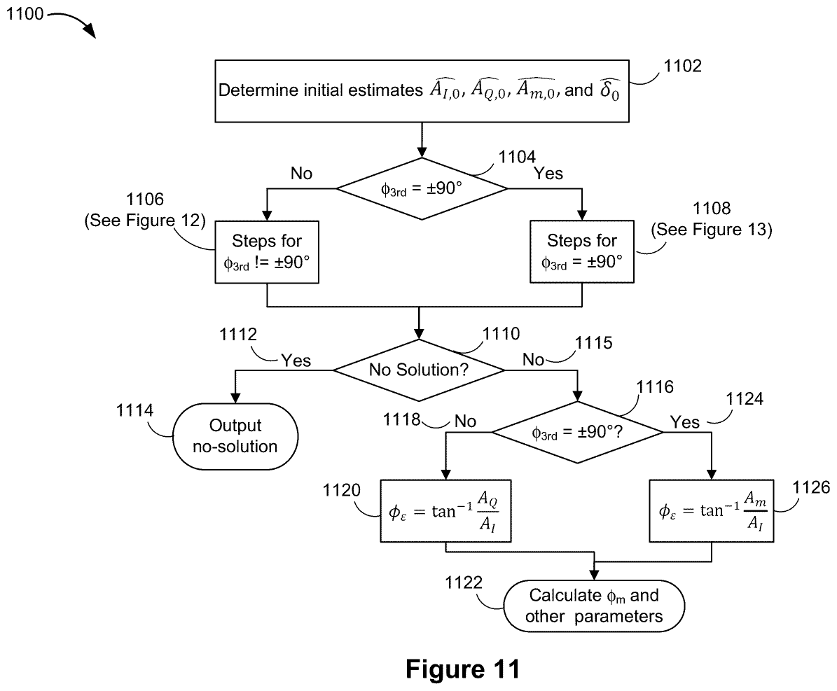

Given the step response model SR(t) and n pairs of correlation measurements I(tᵢ) and Q(tᵢ) along code chip edge transitions, some aspects of the present disclosure estimate the unknown signal parameters (e.g., the carrier phase multipath error ϕ_{ε}, the multipath time delay δ, and the amplitude of the multipath signal Aₘ) in two procedures, also referred to herein as Procedure 1 and Procedure 2, which are described below (e.g., with respect to FIGS. 9 and 11).

In some embodiments, due to the influence of a multipath signal, the code chip edge transition of a direct-path signal can be distorted, and accordingly the code chip edge transition response time can be changed from τ 510, as shown in FIG. 5, to τ+Δt, where the time error Δt is unknown but of interest since it largely reveals the code tracking error and code phase measurement error due to the influence of the multipath signal. To identify the unknown time error Δt, a pair of new measurements x and y are defined as the following:

$$x ( t ) = {A}_{d + m} SR ( {t}^{′} ) - I ( t ) \\ y ( t ) = Q ( t ) \qquad ( 8 )$$

where t represents time, and

$${t}^{′} = t + Δ t \qquad ( 9 )$$

Before Procedure 1 (as will be described with reference to FIG. 9) starts to iteratively solve for the unknown time error Δt, the relationship between x(t) and y(t) needs to be derived first as follows. Based on equations 5 and 6, equation 8 can be rewritten as follows:

$$\begin{matrix}\begin{matrix}x ( t ) = ( {A}_{d} cos {ϕ}_{ε} + {A}_{m} cos {ϕ}_{3 rd} ) SR ( {t}^{′} ) - [ {A}_{d} SR ( t ) cos {ϕ}_{ε} + {A}_{m} SR ( t - δ ) cos {ϕ}_{3 rd} ] \\ = {A}_{d} [ SR ( {t}^{′} ) - SR ( t ) ] cos {ϕ}_{ε} + {A}_{m} [ SR ( {t}^{′} ) - SR ( t - δ ) ] cos {ϕ}_{3 rd}\end{matrix} & ( 10 ) \\ y ( t ) = {A}_{d} SR ( t ) sin {ϕ}_{ε} - {A}_{m} SR ( t - δ ) sin {ϕ}_{3 rd} & ( 11 )\end{matrix}$$

Multiplying equation 10 by

$$tan {ϕ}_{3 rd} = \frac{sin {ϕ}_{3 r d}}{cos {ϕ}_{3 r d}} \qquad ( 12 )$$

$$yields$$

$$x ( t ) tan {ϕ}_{3 rd} = {A}_{d} [ S R ( {t}^{′} ) - S R ( t ) ] cos {ϕ}_{ε} tan {ϕ}_{3 rd} + {A}_{m} [ S R ( {t}^{′} ) - S R ( t - δ ) ] sin {ϕ}_{3 rd} \qquad ( 13 )$$

Subtracting equation 13 from equation 11 results in

$$\begin{matrix}y ( t ) = x ( t ) tan {ϕ}_{3 rd} + {A}_{d} S R ( t ) sin {ϕ}_{ε} - {A}_{d} [ S R ( {t}^{′} ) - S R ( t ) ] cos {ϕ}_{ε} tan {ϕ}_{3 rd} - {A}_{m} S R ( {t}^{′} ) sin {ϕ}_{3 rd} \\ = x ( t ) tan {ϕ}_{3 rd} - {A}_{d} [ SR ( {t}^{′} ) - S R ( t ) ] cos {ϕ}_{ε} tan {ϕ}_{3 rd} + {A}_{m} [ S R ( t ) - SR ( {t}^{′} ) ] sin {ϕ}_{3 rd} \\ = x ( t ) tan {ϕ}_{3 rd} - [ SR ( {t}^{′} ) - S R ( t ) ] ( {A}_{d} cos {ϕ}_{ε} tan {ϕ}_{3 rd} + {A}_{m} sin {ϕ}_{3 rd} ) \\ = x ( t ) tan {ϕ}_{3 rd} - [ SR ( {t}^{′} ) - S R ( t ) ] ( {A}_{d} cos {ϕ}_{ε} + {A}_{m} cos {ϕ}_{3 rd} ) tan {ϕ}_{3 rd} \\ = x ( t ) tan {ϕ}_{3 rd} - [ SR ( {t}^{′} ) - S R ( t ) ] {A}_{d + m} tan {ϕ}_{3 rd} \\ = x ( t ) tan {ϕ}_{3 rd} - {A}_{d + m} \frac{dSR ( {t}^{′} )}{dt} Δ t tan {ϕ}_{3 rd}\end{matrix}$$

stands for the value of

$$\frac{dSR ( t )}{d t}$$

at t′. Un one hand, based on directly given measurement samples of I(t) and Q(t) at tᵢ with i=1, 2, . . . , n, indirect measurements x(t) and y(t) at tᵢ can be calculated as follows:

$$\begin{matrix}x ( {t}_{i} ) = {A}_{d + m} SR ( {t}_{i} + Δ t ) - I ( {t}_{i} ) \\ y ( {t}_{i} ) = Q ( {t}_{i} )\end{matrix} \qquad ( 15 )$$

On the other hand, equation 14 can also be discretized into the following form:

$$y ( {t}_{i} ) = x ( {t}_{i} ) tan {ϕ}_{3 rd} - {A}_{d + m} \frac{dSR ( {t}_{i} + Δ t )}{d t} Δ t tan {ϕ}_{3 rd} \qquad ( 16 )$$

The above equation can be equivalently written into the following matrix equation form:

$$[ \begin{matrix}x ( {t}_{1} ) & - {A}_{d + m} \frac{dSR ( {t}_{1} + Δ t )}{dt} \\ x ( {t}_{2} ) & - {A}_{d + m} \frac{dSR ( {t}_{2} + Δ t )}{dt} \\ ⋮ & ⋮ \\ x ( {t}_{n} ) & - {A}_{d + m} \frac{dSR ( {t}_{n} + Δ t )}{dt}\end{matrix} ] [ \begin{matrix}tan {ϕ}_{3 rd} \\ Δ t tan {ϕ}_{3 rd}\end{matrix} ] = [ \begin{matrix}y ( {t}_{1} ) \\ y ( {t}_{2} ) \\ ⋮ \\ y ( {t}_{n} )\end{matrix} ] \qquad ( 17 )$$

The goal of Procedure 1 is to solve for ϕ_{3rd} and Δt from matrix equation 17. Matrix equation 17 can be solved in several different ways. One way is a Least Squares fitting process. Starting with a set of initial estimates for ϕ_{3rd}, Δt, and A_{d+m} at iteration k, say, [symbol] , [symbol] and [symbol] , the Least Squares fitting process converts n pairs of I(tᵢ) and Q(tᵢ) samples into x(tᵢ) and y tᵢ) values based on equation 15, where i=1, 2, . . . , n, and forms the matrix equation 17. Then, the Least Squares fitting process solves for tan ϕ_{3rd} and Δt tan ϕ_{3rd} from the matrix equation, and generates the k-th estimates of tan ϕ_{3rd} and Δt, i.e., tan [symbol] and [symbol] , respectively, according to

$$= tan {- 1}_{} + {κ}_{ϕ} ( tan {ϕ}_{3 rd} - tan {- 1}_{} ) \qquad ( 18 )$$

$$\text{?} = + {κ}_{Δ t} \frac{Δ t tan {ϕ}_{3 rd}}{tan {ϕ}_{3 rd}} \qquad ( 19 )$$

$$\text{?} \text{indicates text missing or illegible when filed}$$

where, κ_{ϕ} and κ_{Δt} are filter gains, which are usually less than 1. Like equations 18 and 19, many other smoothing or filtering methods can also be validly used to filter instantaneous solutions from equation 17. Starting with newly updated estimates tan [symbol] and [symbol] , the Least Squares fitting process performs a new iteration (e.g., iteration k+1), if needed (e.g., if the Least Squares fitting process has not yet converged), as discussed below with reference to FIG. 9.

Equation 19 indicates that estimate [symbol] is the sum of the previous estimate [symbol] and instantaneous solution Δt, and then this essentially accumulated estimate [symbol] k is used to convert I(tᵢ) to x(tᵢ) using equation 15. In some embodiments, the instantaneous solution Δt will be very close to zero as the Least Squares fitting process iterates and converges. Once the Least Squares fitting process converges and Δt is very close to zero, both equations 16 and 17 suggest that small errors in estimate [symbol] should not be a concern, because the product of [symbol] and Δt will eventually approach to zero.

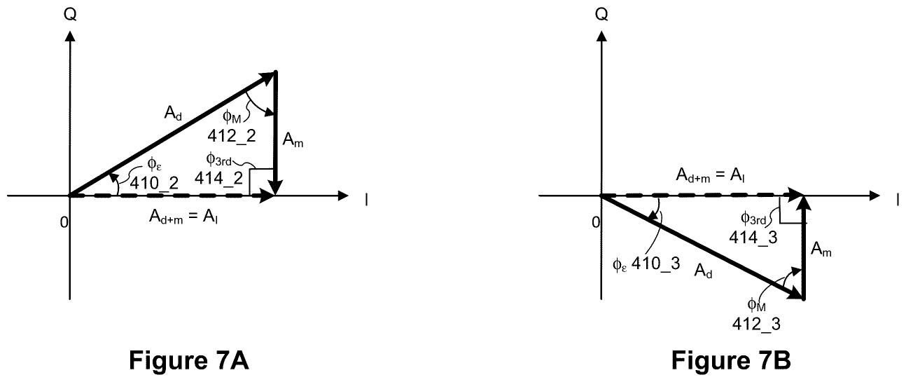

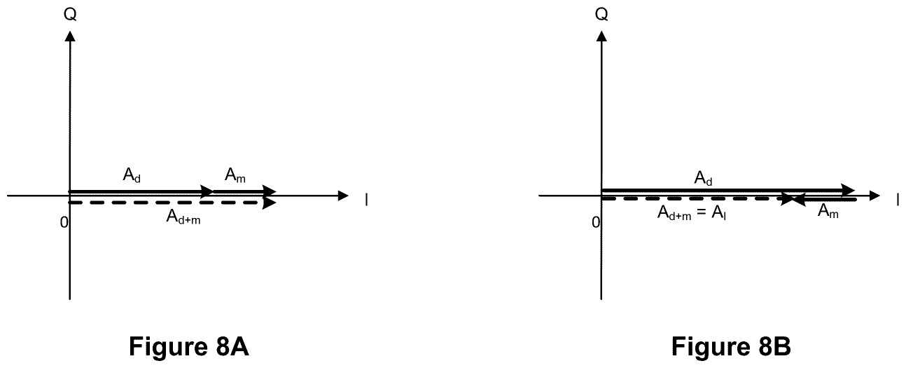

Not all multipath scenarios can be handled by equation 17. For example, in some scenarios, the angle ϕ_{3rd} is equal or very close to either +90° or −90°, as illustrated in FIG. 7A and FIG. 7B, respectively. Accordingly, tan ϕ_{3rd} will approach±infinity, and thus solving the corresponding matrix equation 17 will be numerically impossible. In another scenario, the angle ϕ_{3rd} is equal or very close to either 0° or 180°, as illustrated FIG. 8A and FIG. 8B, respectively, and thus tan ϕ_{3rd} has a value that is very close to zero. If tan ϕ_{3rd} is equal or very close to zero, then all multiplications in the matrix equation 17 will produce values that are zero or close to zero, and the right-hand side y(tᵢ) of equation 16 should also be zero in theory, and thus solving matrix equation 17 will be numerically unreliable or meaningless. Accordingly, in some embodiments, as discussed below, different equations and algorithms are used to solve for ϕ_{3rd} and Δt in these scenarios, which cannot be covered by equation 17.

Further, when angle ϕ_{3rd} is equal or very close to either +90° or −90°, i.e., cos ϕ_{3rd}=0, the I component of Equation 7 becomes

$$I ( {t}_{i} ) = {A}_{d} S R ( {t}_{i} ) cos {ϕ}_{ε} = {A}_{I} SR ( {t}_{i} ) \qquad ( 20 )$$

where A_{I} is defined as

$${A}_{I} = {A}_{d} cos {ϕ}_{ε} \qquad ( 21 )$$

Equation 20 indicates a mechanism of detecting whether a received satellite signal includes a multipath signal for which ϕ_{3rd}=±90°: if function I(tᵢ) has the same shape as the chip edge transition model SR(tᵢ), then this (e.g., the received satellite signal, including both direct and multipath signals) is a multipath scenario of ϕ_{3rd}=±90°. Equation 20 can be equivalently written into the following matrix form:

$$[ \begin{matrix}SR ( {t}_{1} ) \\ SR ( {t}_{2} ) \\ ⋮ \\ SR ( {t}_{n} )\end{matrix} ] {A}_{I} = [ \begin{matrix}I ( {t}_{1} ) \\ I ( {t}_{2} ) \\ ⋮ \\ I ( {t}_{n} )\end{matrix} ] \qquad ( 22 )$$

Unknown A_{I} can be easily solved from the above linear matrix equation by, for example, a Least Squares method. With A_{I} being solved, the Mean Squared Error (MSE) of this estimation can be calculated as

$${MSE}_{{A}_{I}} = \frac{1}{n} {{\sum }_{i = 1}^{n} [ I ( {t}_{i} ) - {A}_{I} SR ( {t}_{i} ) ]}^{2} \qquad ( 23 )$$

The smaller the value of MSE_{A}_{_{I}}, the higher the similarity between measurement samples I(tᵢ) and step response model samples SR(tᵢ). If MSE_{A}_{_{I}} is small enough, then the multipath scenario for the received satellite signal can be treated as a case of ϕ_{3rd}=±90°.

FIG. 9 is a workflow 900 for Procedure 1 of the phase multipath mitigation algorithm, in accordance with some embodiments. In some embodiments, the workflow 900 is performed by a GNSS receiver, such as the GNSS receiver 170 in FIG. 1B, or by a computing device (e.g., computer system 130, FIG. 1C).

The workflow 900 includes obtaining (902) inputs corresponding to n pairs of I(tᵢ) and Q(tᵢ) along chip edge transitions with i=1, 2, . . . , n (e.g., corresponding to I(t₁) 259-1I and Q(t₁) 259-1Q, I(t₂) 259-2I and Q(t₂) 259-2Q, . . . , and I(tₙ) 259-nI and Q(tₙ) 259-nQ). In some embodiments, the n pairs of I(tᵢ) and Q(tᵢ) are delivered by integrate and dump circuits 260 as illustrated in FIG. 2. Meanwhile, the chip edge transition model SR(t) or SR(tᵢ) is pre-determined and therefore available. An example of a pre-determined chip edge transition model SR(t) or SR(tᵢ) is been illustrated in FIGS. 5 and 6. As can be seen in these figures, the amplitude of SR(t) is normalized to 1. Accordingly, in some embodiments, all correlation samples I(tᵢ) and Q(tᵢ) are normalized by the same amount before they are input to the phase multipath mitigation algorithm.

The workflow 900 includes determining (904) a sign of carrier phase multipath error ϕ_{ε} 410. As described with reference to FIG. 4B, the sign of ϕ_{ε} is positive if a triangle formed by the direct-path signal phasor vector, the multipath signal phasor vector, and the composite signal phasor vector is in the first quadrant (e.g., Quadrant 1 416 in FIG. 4B). Otherwise, the sign of ϕ_{ε} is negative if the triangle is in the fourth quadrant (e.g., Quadrant 4 418 in FIG. 4B). Given n samples of Q(tᵢ), one embodiment calculates their magnitudes |Q(tᵢ)|, searches for the maximum, say, |Q(tⱼ)| is the maximum, checks the sign of this sample Q(tᵢ), and then the sign of that sample Q(tⱼ) is assigned to the sign of de. The importance of determining the sign of ϕ_{ε} is described below.

The workflow 900 includes checking (906) the similarity between I(tᵢ) and SR(tᵢ) to determine whether the current multipath scenario is a case of ϕ_{3rd}=±90°. This involves solving for A, from equation 22, calculating the Mean Squared Error, MSE_{A}_{_{I}} using equation 23, and comparing (908) the value of MSE_{A}_{_{I}} to a pre-determined threshold value (e.g., Threshold1). If MSE_{A}_{_{I}} is smaller than (or smaller than or equal to) the threshold (910), it is a multipath case of ϕ_{3rd}=±90° (912). Otherwise, if MSE_{A}_{_{I}} is larger than (or larger than or equal to) the pre-determined threshold (908-No), then ϕ_{3rd} is not=±90°. If the current multipath scenario is detected as a case of ϕ_{3rd}=±90°, then ϕ_{3rd} is equal to +90° if the sign of @ has been determined as positive; otherwise, ϕ_{3rd} is −90° if the sign of ϕ_{ε} is negative.

If the current multipath scenario is not a case of ϕ_{3rd}=±90°, the workflow 900 continues with the path indicated by step 914, to iteratively solve for ϕ_{3rd} and Δt, using a first iterative process. At the beginning of the first iterative process, an iteration count, e.g., k, representing a number of iterations of the first iterative process is set or reset to an initial value, e.g., 1. In addition, before the first iterative process begins, the values of parameters ϕ_{3rd}, Δt and A_{d+m} are estimated (916) (e.g., initial estimates of these values are set, determined or obtained). In some embodiments, the initial estimates of both ϕ_{3rd} and Δt are set to 0, i.e., [symbol] =0 and [symbol] =0 for the first iteration, i.e., k=1. As used herein, the term [symbol] (referred to as “x hat”) denotes an estimate of parameter x in iteration k. In some embodiments, [symbol] is used as the initial estimate for a next iteration (i.e., iteration k+1) of the first iterative process.

In some embodiments, the initial estimate of A_{d+m}, i.e., [symbol] , can be set as the magnitude of the last pair of I and Q samples for a code chip edge-up transition, e.g.,

$$= \sqrt{{[ I ( {t}_{n} ) ]}^{2} + {[ Q ( {t}_{n} ) ]}^{2}} \qquad ( 24 )$$

Otherwise, in some embodiments, the initial estimate [symbol] can be assigned using the magnitude of the first pair of I and Q samples, e.g., I(t₁) and Q(t₁) for a chip edge-down transition. The estimate [symbol] is not updated in the Least Squares fitting process; however, the estimation of A_{d+m} using equation 24 is quite accurate and reliable, and as explained above, any error in estimate [symbol] should not be a concern as the Least Squares fitting process converges.

Starting with initial estimates [symbol] , [symbol] ₖ₋₁ and [symbol] at iteration k, the Least Squares fitting process converts n pairs of I(tᵢ) and Q(tᵢ) samples into x(tᵢ) and y(tᵢ) (in step 918) based on equation 15 with i=1, 2, . . . , n, constructs the matrix equation 17, and solves for tan ϕ_{3rd} and Δt tan ϕ_{3rd} using the Least Squares method. To avoid any potential “divided by zero” error, and more importantly, to check whether the current multipath scenario is a case of ϕ_{3rd}=0° or 180°, the absolute value of tan ϕ_{3rd}, i.e., |tan ϕ_{3rd}|, is compared to (920) another predefined threshold (e.g., Threshold 2) which is typically a very small positive value. If |tan ϕ_{3rd}| is smaller than the predefined threshold (e.g., Threshold2) (922), this is a case of ϕ_{3rd}=0° or 180° (924). Otherwise, if |tan ϕ_{3rd}| is larger than the predefined threshold (e.g., Threshold2) (926), then this is not a case of ϕ_{3rd}=0° or 180°. It is noted that this document references multiple thresholds, each of which may be different than the other threshold, and each of which may be set so as to make the multipath mitigation process both efficient and reliable.

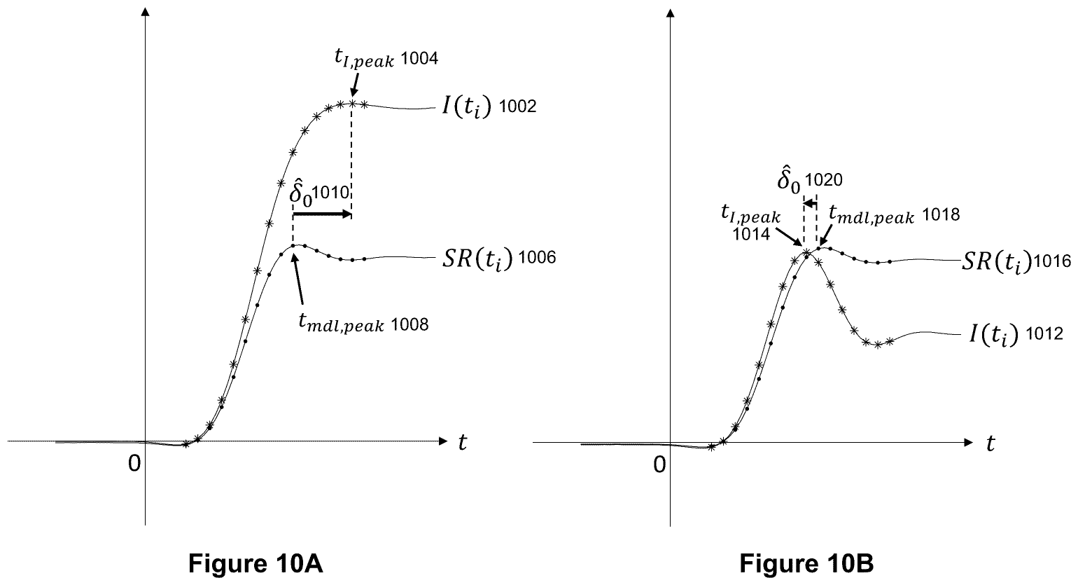

If the multipath scenario for a received satellite signal is detected as a case of ϕ_{3rd}=0° or 180°, further determination on whether ϕ_{3rd} is equal to 0° or 180° is needed. Recall that FIG. 8A shows a multipath scenario of ϕ_{3rd}=0° where a multipath signal is in phase with a direct-path signal and FIG. 8B shows a multipath scenario of ϕ_{3rd}=180° where a multipath signal is 180° out of phase with a direct-path signal. As basic knowledge on GPS/GNSS code correlation and multipath, the peak of their composited correlations will shift to right (i.e., be delayed) if a multipath signal is in phase with its direct-path signal. In contrast, the peak of their composited correlations will shift to left (i.e., be advanced) if a multipath signal is 180° out of phase with its direct-path signal. Using this GPS/GNSS knowledge, a mechanism of determining whether ϕ_{3rd} is 0° or 180° is devised. As illustrated in FIG. 10A, if the peak t₁,peak 1004 of I(tᵢ) samples 1002 is located to the right-hand side of the peak t_{mdl,peak} 1008 of SR(tᵢ) samples 1006, then ϕ_{3rd}=0°; otherwise, as illustrated in FIG. 10B, if the peak t_{l,peak} 1014 of I(tᵢ) samples 1012 is located to the left-hand side of the peak t_{mdl,peak} 1018 of SR(tᵢ) samples 1016, then ϕ_{3rd}=180°. In FIGS. 10A and 10B, the star markers represent I(tᵢ) measurement samples, and the dot markers represent the code chip edge transition model samples SR(tᵢ). In either case, the carrier phase multipath error ϕ_{ε} is 0. In other words, if there is some uncertainty or error (e.g., within predefined margins) in determining whether ϕ_{3rd} is either 0° or 180°, the uncertainty or error is tolerable and does not affect the accuracy of estimating the carrier phase multipath error ϕ_{ε}.

With continued reference to FIG. 9, if a multipath scenario is not a case of ϕ_{3rd}=0° or 180° (920—No, 926) and not a case of ϕ_{3rd}=±90° (908—No, 914), the Least Squares fitting process updates (928) the estimate of tan ϕ_{3rd} and Δt based on equations 18 and 19 to obtain new estimates tan [symbol] and [symbol] at this k^{th} iteration, respectively. The workflow 900 then proceeds to determine (930) whether the Least Squares fitting process has converged, diverged or not. Several different aspects can be considered. In some embodiments, if the magnitude of estimate [symbol] (i.e., [symbol] ) is smaller than a threshold, the workflow 900 determines that the Least Squares fitting process has converged (932), outputs a solution for ϕ_{3rd} (934), and terminates the first iterative process. In some embodiments, if the change of estimates of tan ϕ_{3rd} in the last two iterations (e.g., |tan [symbol] −tan [symbol] |) is smaller than a predetermined threshold, then workflow 900 determines that the Least Squares fitting process has converged (932), outputs a solution for ϕ_{3rd} (934), and terminates the iterative process.

In some embodiments, if the number of iterations, k, for which the Least Squares fitting process has looped is larger than a threshold (930) (e.g.,k>Threshold3), the workflow 900 determines that the iterative process has diverged (or at least cannot converge anymore) and therefore terminates the iterative process without producing a solution for ϕ_{3rd} (934). Otherwise (e.g., k<Threshold3 or k≤Threshold3), since the process has yet to converge but has not diverged, the workflow 900 repeats the iterative process after increasing the number of iterations k by 1 (938).

If the Least Squares fitting process has successfully converged, the updated estimates of tan ϕ_{3rd} and Δt obtained from the last iteration are regarded as the final solutions. The value of parameter ϕ_{3rd} can be calculated from the solution tan ϕ_{3rd} using arctangent function, i.e.,

$${ϕ}_{3 rd} = {tan}^{- 1} ( tan {ϕ}_{3 rd} ) \qquad ( 25 )$$

However, arctangent function tan⁻¹(·) returns an angle in a range of −90° to +90°, while ϕ_{3rd} can be in a range of −180° to +180°. To resolve this ambiguity, the sign of carrier phase error ϕ_{ε}, which was determined in step 904, is utilized again: if the sign of carrier phase error ϕ_{ε} is positive while ϕ_{3rd} calculated from arctangent is negative, then ϕ_{3rd}+180° is re-assigned to the final solution of ϕ_{3rd}; similarly, if the sign of ϕ_{ε} is negative while ϕ_{3rd} calculated from arctangent is positive, then ϕ_{3rd}−180° is re-assigned to the final ϕ_{3rd}.

Procedure 1 has solved parameter ϕ_{3rd} and parameter Δt, based on the results of the last iteration of Procedure 1 (e.g., using equations 18 and 19), while Procedure 2 (as described in FIGS. 11, 12, and 13) will continue to solve for the remaining signal parameters, e.g., A_{d}, Aₘ, ϕₘ, δ, and the carrier phase error ϕ_{ε}. In some instances, Procedure 1 may fail to converge and deliver a no-solution (e.g., no valid solution). If this happens, Procedure 2 will not be executed.

The derivation of equations for Procedure 2 also starts with I and Q measurement model equation 7, which is now rewritten into the following form:

$$\begin{matrix}I ( {t}_{i} ) = {A}_{I} SR ( {t}_{i} ) + {A}_{m} SR ( {t}_{i} - δ ) cos {ϕ}_{3 rd} \\ Q ( {t}_{i} ) = {A}_{Q} S R ( {t}_{i} ) - {A}_{m} SR ( {t}_{i} - δ ) sin {ϕ}_{3 rd}\end{matrix} \qquad ( 26 )$$

where, A_{I} is defined in Equation 21, and

$${A}_{Q} = {A}_{d} sin {ϕ}_{ε} \qquad ( 27 )$$

Equation 26 has four unknowns A_{I}, A_{Q}, Aₘ, and δ. Since Equation 26 is non-linear, Taylor expansion and linearization techniques are applied here. Given initial estimates of these four unknowns at iteration k, noted as [symbol] , [symbol] , [symbol] , and [symbol] , the Taylor expansion of I(tᵢ) and Q(t_{I}) at these initial estimates can be expressed as:

$$I ( {t}_{i} ) = \hat{I} ( {t}_{i , k - 1} ) + SR ( {t}_{i} ) {Δ}_{{A}_{I}} + SR ( {t}_{i} - ) cos {ϕ}_{3 r d} {Δ}_{{A}_{m}} - \frac{\partial SR ( {t}_{i} - )}{\partial t} cos {ϕ}_{3 r d} {Δ}_{δ} \qquad ( 28 )$$

$$Q ( {t}_{i} ) = \hat{Q} ( {t}_{i , k - 1} ) + SR ( {t}_{i} ) {Δ}_{{A}_{Q}} - SR ( {t}_{i} - ) sin {ϕ}_{3 r d} {Δ}_{{A}_{m}} + \frac{\partial SR ( {t}_{i} - )}{\partial t} sin {ϕ}_{3 r d} {Δ}_{δ}$$

where, the 2^{nd} and higher order terms are omitted, Î(t_{i,k-1}) and \hat{Q}(t_{i,k-1}) are the estimated values of I(tᵢ) and Q(tᵢ) at [symbol] , [symbol] , [symbol] , and [symbol] , i.e.,

$$\hat{I} ( {t}_{i , k - 1} ) = SR ( {t}_{i} ) + SR ( {t}_{i} - cos {ϕ}_{3 r d} \qquad ( 29 )$$

$$\hat{Q} ( {t}_{i , k - 1} ) = SR ( {t}_{i} ) - SR ( {t}_{i} - sin {ϕ}_{3 r d}$$

and

$$\frac{\partial SR ( {t}_{i} -}{\partial t}$$

stands for

$$\frac{\partial SR ( t )}{\partial t} at t = {t}_{i} - ,$$

and it is equivalent to

$$- \frac{\partial SR ( {t}_{i} - δ )}{\partial δ} at δ = .$$

Equation 28 can be rewritten into the following form:

$${y}_{I} ( {t}_{i , k} ) = SR ( {t}_{i} ) {Δ}_{{A}_{I}} + SR ( {t}_{i} - ) cos {ϕ}_{3 r d} {Δ}_{{A}_{m}} - \frac{\partial SR ( {t}_{i} - )}{\partial t} cos {ϕ}_{3 r d} {Δ}_{δ} \qquad ( 30 )$$

$${y}_{Q} ( {t}_{i , k} ) = SR ( {t}_{i} ) {Δ}_{{A}_{Q}} - SR ( {t}_{i} - ) sin {ϕ}_{3 r d} {Δ}_{{A}_{m}} + \frac{\partial SR ( {t}_{i} - )}{\partial t} sin {ϕ}_{3 r d} {Δ}_{δ}$$

where, y_{I}(tᵢ) and y_{Q}(tᵢ) are the differences between I & Q measurements and their corresponding estimates, i.e.,

$${y}_{I} ( {t}_{i , k} ) = I ( {t}_{i} ) - \hat{I} ( {t}_{i , k - 1} ) \qquad ( 31 )$$

$${y}_{Q} ( {t}_{i , k} ) = Q ( {t}_{i} ) - \hat{Q} ( {t}_{i , k - 1} )$$

Equivalently, equation 30 can be written into the following two matrix equations:

$$[ \begin{matrix}SR ( {t}_{1} ) & SR ( {t}_{1} - ) & \frac{\partial SR ( {t}_{1} - \overline{{δ}_{k - 1}} )}{\partial t} \\ SR ( {t}_{2} ) & SR ( {t}_{2} - ) & \frac{\partial SR ( {t}_{2} - \overline{{δ}_{k - 1}} )}{\partial t} \\ ⋮ & ⋮ & ⋮ \\ SR ( {t}_{n} ) & SR ( {t}_{n} - ) & \frac{\partial SR ( {t}_{n} - \overline{{δ}_{k - 1}} )}{\partial t}\end{matrix} ] [ \begin{matrix}{Δ}_{{A}_{I}} \\ cos {ϕ}_{3 r d} {Δ}_{{A}_{m}} \\ - cos {ϕ}_{3 r d} {Δ}_{δ}\end{matrix} ] = [ \begin{matrix}{y}_{I} ( {t}_{1 , k} ) \\ {y}_{I} ( {t}_{2 , k} ) \\ ⋮ \\ {y}_{I} ( {t}_{n , k} )\end{matrix} ] \qquad ( 32 )$$

$$[ \begin{matrix}SR ( {t}_{1} ) & SR ( {t}_{1} - ) & \frac{\partial SR ( {t}_{1} - \overline{{δ}_{k - 1}} )}{\partial t} \\ SR ( {t}_{2} ) & SR ( {t}_{2} - ) & \frac{\partial SR ( {t}_{2} - \overline{{δ}_{k - 1}} )}{\partial t} \\ ⋮ & ⋮ & ⋮ \\ SR ( {t}_{n} ) & SR ( {t}_{n} - ) & \frac{\partial SR ( {t}_{n} - \overline{{δ}_{k - 1}} )}{\partial t}\end{matrix} ] [ \begin{matrix}{Δ}_{{A}_{Q}} \\ cos {ϕ}_{3 r d} {Δ}_{{A}_{m}} \\ - cos {ϕ}_{3 r d} {Δ}_{δ}\end{matrix} ] = [ \begin{matrix}{y}_{Q} ( {t}_{1 , k} ) \\ {y}_{Q} ( {t}_{2 , k} ) \\ ⋮ \\ {y}_{Q} ( {t}_{n , k} )\end{matrix} ] \qquad ( 33 )$$

As can be seen, the coefficient matrices in the matrix equations 32 and 33 happen to be same. Once Δ_{A}_{_{I}}, Δ_{A}_{_{Q}}, Δ_{A}_{ₘ}, and Δ_{δ} are solved from equations 32 and 33, estimates of A_{I}, A_{Q}, Aₘ, and δ at iteration k can be updated as follows:

$$= + {κ}_{{A}_{I}} {Δ}_{{A}_{I}} \qquad ( 34 )$$

$$= + {κ}_{{A}_{Q}} {Δ}_{{A}_{Q}} \qquad ( 35 )$$

$$= + {κ}_{{A}_{m}} {Δ}_{{A}_{m}} \qquad ( 36 )$$

$$= + {κ}_{δ} {Δ}_{δ} \qquad ( 37 )$$

Given the updated estimates [symbol] , [symbol] , [symbol] , and [symbol] from iteration k, Procedure 2 can start a new iteration (e.g., iteration k+1) and so on, until the process converges.

Since Δ_{A}_{ₘ} and Δ_{δ} are common unknowns for equations 32 and 33, there are several different approaches for solving these two equations and combining their solutions. One approach is to solve equations 32 and 33 separately, while estimates of A_{I}, Aₘ and δ for equation 32 are updated based on equations 34, 36 and 37, and estimates of A_{Q}, Aₘ and δ for equation 33 are updated based on equations 35, 36 and 37. Once the solutions to these two equations both have converged separately, the final solution Aₘ can be a weighted sum of the solution Aₘ from equation 32 and the other Aₘ from equation 33. Similarly, the final solution δ can also be a weighted sum of the two δ solutions from equations 32 and 33.

Another approach involves converting/combining the two n×3 matrix equations (equations 32 and 33) into one (2n)×4 matrix equation with a total of four unknowns (e.g., unknowns Δ_{A}_{_{I}}, Δ_{A}_{_{Q}}, Δ_{A}_{ₘ}, and Δ_{δ}), and solving the (2n)×4 matrix equation (e.g., instead of combining solutions).

A third approach for solving equations 32 and 33 and combining their solutions is described here. First, equation 32 is solved to obtain solutions A_{I}, Aₘ and δ. Because the unknowns Aₘ and δ have been solved, their values are now known. Thus, when Q(tᵢ) in equation 26 is Taylor expanded and linearized, it becomes

$$Q ( {t}_{i} ) = \hat{Q} ( {t}_{i , k - 1} ) + SR ( {t}_{i} ) {Δ}_{{A}_{Q}} \qquad ( 38 )$$

where \hat{Q}(t_{i,k-1}) is the estimated value of Q(tᵢ) at [symbol] at the beginning of iteration k, i.e.,

$$\hat{Q} ( {t}_{i , k - 1} ) = SR ( {t}_{i} ) - {A}_{m} SR ( {t}_{i} - δ ) sin {ϕ}_{3 r d} \qquad ( 39 )$$

Accordingly, the equation regarding y_{Q}(t_{i,k}), which is defined in equation 31, now becomes the following:

$${y}_{Q} ( {t}_{i , k} ) = SR ( {t}_{i} ) {Δ}_{{A}_{Q}} \qquad ( 40 )$$

or equivalently in a matrix form:

$$[ \begin{matrix}SR ( {t}_{1} ) \\ SR ( {t}_{2} ) \\ ⋮ \\ SR ( {t}_{n} )\end{matrix} ] {Δ}_{{A}_{Q}} = [ \begin{matrix}{y}_{Q} ( {t}_{1 , k} ) \\ {y}_{Q} ( {t}_{2 , k} ) \\ ⋮ \\ {y}_{Q} ( {t}_{n , k} )\end{matrix} ] \qquad ( 41 )$$

Equation 35 can still be used to update [symbol] iteratively. In other words, the third approach solves matrix equation 41 (instead of matrix equation 33) to obtain A_{Q}. The third approach offers two advantages. First, it solves for all possible unknowns (i.e., A_{I}, Aₘ and δ) based solely on higher signal-to-noise ratio (SNR) measurements I(tᵢ) and the corresponding y_{I} (tᵢ), while measurements Q(tᵢ) and the corresponding y_{Q}(tᵢ) are often close to zero in value and have a much lower SNR. Therefore, this approach can deliver more accurate solutions. Second, instead of solving two n×3 matrix equations (questions 32 and 33) (using the first approach) or a solving (2n)×4 matrix equation (using the second approach), the third approach solves a n×3 matrix (equation 32) and a n×1 matrix (equation 41), thus reducing the amount of computational power used to produce a solution. Furthermore, compared to other larger-sized matrices, an n×1 matrix equation (e.g., equation 41) typically converges in fewer iterations (e.g., two or three iterations). Therefore, solutions for the unknown parameters can be obtained more quickly and efficiently.

FIG. 11 illustrates a workflow 1100 for Procedure 2 of the phase multipath mitigation algorithm, in accordance with some embodiments. In some embodiments, the workflow 1100 is performed by a GNSS receiver (e.g., navigation signal receiver 120 or GNSS receiver 170) or by a computing device (e.g., computer system 130, FIG. 1C). Typically, the steps in the workflow 1100 are executed after Procedure 1 (described in the workflow 900) outputs a valid estimation for the carrier phase multipath error ϕ_{3rd}.

The workflow 1100 includes determining (1102) initial estimates, [symbol] , [symbol] , [symbol] , and [symbol] , of four unknown parameters, A_{I}, A_{Q}, Aₘ, and δ.

In some embodiments, the initial estimates [symbol] and [symbol] can be assigned with the last pair of correlation measurements, i.e., I(tₙ) and Q(tₙ).

In some embodiments, if Procedure 1 (e.g., the workflow 900) determines that this is a multipath scenario with ϕ_{3rd}=±90°, then [symbol] can assigned to the value of A_{I} that has been solved for from equation 22. As will be shown later, the final solution of A, is also equal to this value.

In some embodiments, if Procedure 1 determines that this is a multipath scenario with ϕ_{3rd}=0° or 180°, then [symbol] can assigned to 0. As will be shown later, the final solution of A_{Q} in this case is also 0.

In some embodiments, the initial multipath signal amplitude estimate [symbol] can be usually set at 0.5, e.g., half of the amplitude which is used to normalize the chip edge transition model SR(t) and correlation samples I(tᵢ) and Q(tᵢ).

In some embodiments, for a very weak direct-path signal partially indicated by a small value of A_{I,0}, the estimate [symbol] can be scaled down accordingly. Equation 26 shows that I(tᵢ) and Q(tᵢ) measurement models are linear with parameters A_{I}, A_{Q} and Aₘ, so these initial estimates typically work well.

Equation 26 shows that both I(tᵢ) and Q(tᵢ) measurement models are highly nonlinear functions in terms of the multipath time delay parameter δ, and therefore it is critical to make its initial estimate [symbol] as accurate as possible. As illustrated in FIGS. 10A and 10B, assuming the peak sample of the chip edge transition model SR(tᵢ) is located at time t_{mdl,peak} (e.g., t_{mdl,peak} 1008 in FIG. 10A and t_{mdl,peak} 1018 in FIG. 10B), and the peak value of I(tᵢ) measurement samples is found to be at time t_{I,peak} (e.g., t_{I,peak} 1004 in FIG. 10A and t_{I,peak} 1014 in FIG. 10B), the initial multipath time delay estimate [symbol] (e.g., [symbol] 1010 in FIG. 10A and [symbol] 1020 in FIG. 10B) can be set as

$$= \vert {t}_{I , peak} - {t}_{mdl , peak} \vert \qquad ( 42 )$$

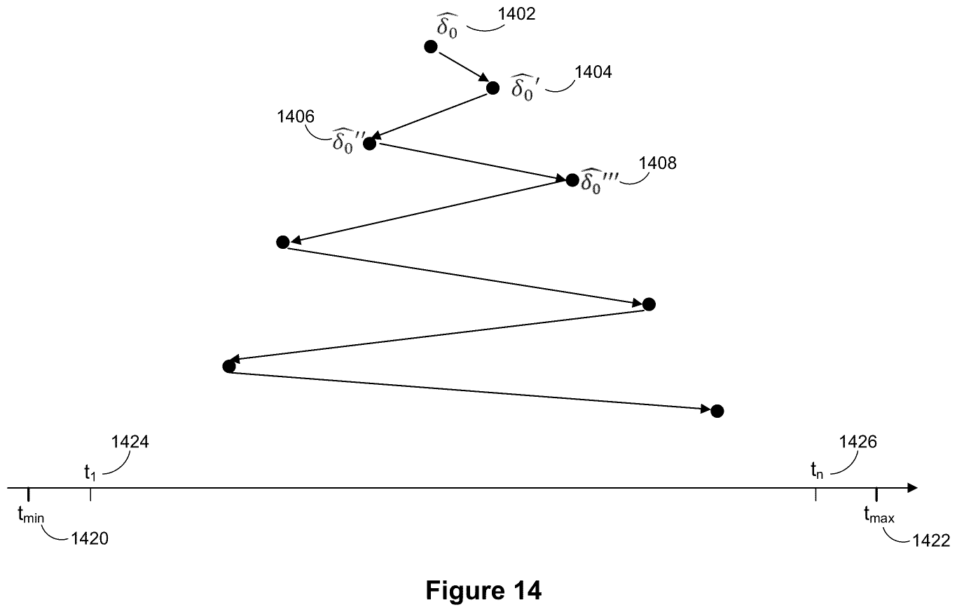

If later the Least Squares fitting process cannot converge using this estimate [symbol] , it suggests this estimate [symbol] is probably too erroneous. As will be explained later, in FIG. 14, there exists a mechanism of trying other values of [symbol] if needed. Although FIGS. 10A and 10B are examples of I(tᵢ) measurement samples when angle ϕ_{3rd} is equal to 0° and 180°, respectively, this method of estimating δ is valid for all multipath scenarios.

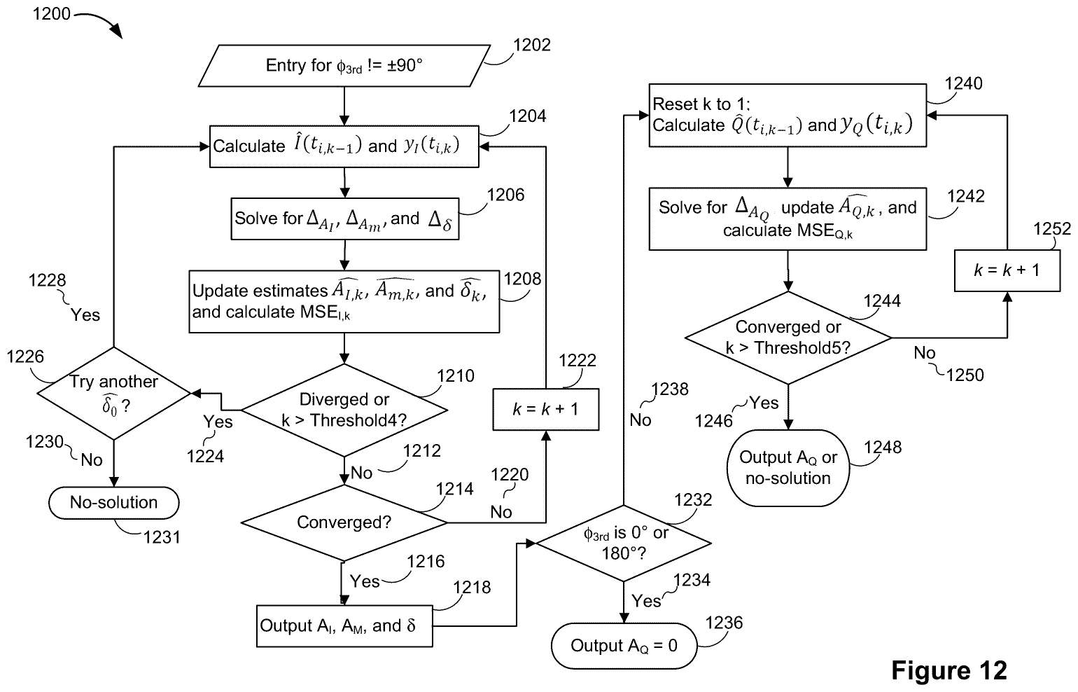

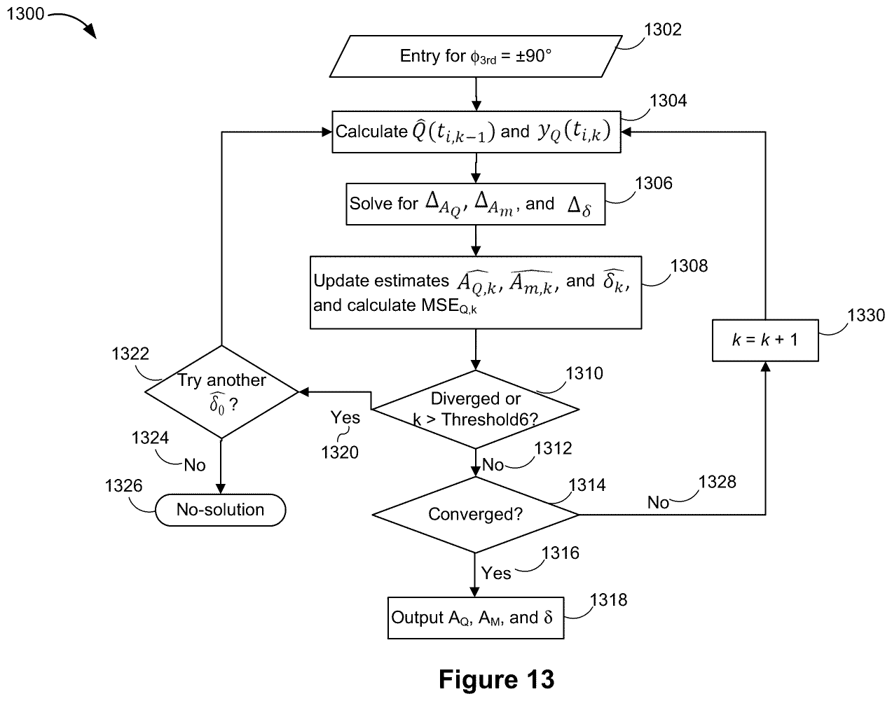

Having determined the initial estimates [symbol] , [symbol] , [symbol] , and [symbol] , Procedure 2 selects an appropriate algorithm to iteratively solve for the unknown parameters, A_{I}, A_{Q}, Aₘ, and δ, depending on whether ϕ_{3rd} is equal to ±90° or not (1104). If Procedure 1 determines that ϕ_{3rd} is not equal to ±90° (1104—No, 1106), then the steps in workflow 1200 (FIG. 12) are executed. Otherwise, if Procedure 1 determines that ϕ_{3rd} is equal to ±90° (1104—Yes, 1108), then the steps in workflow 1300 (FIG. 13) are executed.

FIG. 12 illustrates a workflow 1200 for solving the unknown parameters, A_{I}, A_{Q}, Aₘ, and δ when ϕ_{3rd} is not ±90°, in accordance with some embodiments. When ϕ_{3rd} is not equal to ±90° (1202), an iterative process at iteration k first estimates (1204) I measurements, Î(t_{i,k-1}), based on initial estimates [symbol] , [symbol] and [symbol] using equation 29, calculates its estimation error y_{I}(t_{i,k}) using equation 31, constructs I-matrix equation 32, and solves for unknowns Δ_{A}_{_{I}}, Δ_{A}_{ₘ} and Δ_{δ} using the Least-Squares method (1206). The workflow 1200 updates (1208) [symbol] , [symbol] and [symbol] using equations 34, 36 and 37. Meanwhile, a post-fix MSE_{I,k} at each iteration is also calculated as follows:

$$M S {E}_{I , k} = \frac{1}{n} {{\sum }_{i = 1}^{n} [ {y}_{I} ( {t}_{i , k + 1} ) ]}^{2} \qquad ( 43 )$$

At the end of each iteration (e.g., iteration k), the workflow 1200 includes determining (1210) whether the iterative process has diverged or the number of iterations, k, is larger than a threshold (e.g., Threshold4). If estimates are out of their valid ranges (e.g., estimate [symbol] is larger than the allowably maximal time delay corresponding to the last pair of correlators (i.e., tₙ), or [symbol] is less than 0, or estimate [symbol] is less than 0), then the workflow 1200 determines that the iterative process has diverged (1224). This is because, since a multipath signal must travel through a longer path than its direct-path signal, the multipath time delay δ should always be larger than 0. However, if [symbol] is larger than tₙ, it means that the multipath signal effect is not observable even by the last pair of correlators. If [symbol] is less than 0, it means multipath signal is either too weak or does not exist. These thresholds may need some fine-tuning or margin, since, for example, [symbol] may oscillate to a slightly negative value before converging to a small positive one.

With continued reference to FIG. 12, if the iterative process has not diverged and k is smaller than a threshold (1212), the workflow 1200 includes determining whether the iterative process has converged (1214). The way of determining convergence here is similar to the one in Procedure 1: if changes in the estimates between two latest iterations are smaller than the corresponding thresholds, and/or if the change in MSE_{I}, i.e., |MSE_{I,k}−MSE_{I,k-1}|, is smaller than a threshold, and/or if MSE_{I,k} itself is smaller than a threshold, then the workflow 1200 determines that the iterative process has converged (1216); otherwise, the iterative process has not converged yet (1220). If the iterative process has converged, the I-matrix equation 32 has been successfully solved, and thus parameters A_{I}, Aₘ and δ are obtained (1218). Otherwise, if the iterative process has not converged yet, a new iteration with k=k+1 is performed (1222).

FIG. 12 also illustrates that in some instances, if the iterative process has diverged or if k is larger than a threshold (1224), then the current iteration is terminated and a no-solution (e.g., no valid solution) is output (1231). In some instances, divergence may be caused by a bad initial estimate [symbol] . In these situations, a new, different initial estimate [symbol] is tried, as illustrated in steps 1226 and 1228.

In some embodiments, a series of different initial estimates [symbol] can be tried sequentially (e.g., in a “tree pattern”). This is illustrated in FIG. 14. If the first estimate [symbol] 1402 results in a divergence, a second new estimate [symbol] 1404 can be adjusted to its right. If the second estimate [symbol] 1404 also fails, then a third new estimate [symbol] 1406 with a value smaller than the first estimate [symbol] 1402 can be tried. If the third estimate [symbol] 1406 also fails, then a fourth estimate [symbol] 1408 having a value that is larger (e.g., to the right of) than the second estimate [symbol] 1404 can be tried. In some embodiments, the adjustment step size can be a constant (e.g., equal to the correlator spacing). The range for the adjustments, say, from tₘᵢₙ 1420 to tₘₐₓ 1422, should cover all correlation sample times, i.e., from t₁ 1424 to tₙ 1426, with some margin. Once an adjustment moves beyond this range, it means that all possible initial estimates in this corresponding direction have been tried. If the adjustments have covered the whole range, the iterative process terminates with an output that there is no valid solution. This is shown as steps 1230 and 1231 in FIG. 12.

Once the workflow 1200 has successfully solved for parameters A_{I}, Aₘ and δ from I-matrix equation 32 (1218), it will continue to solve for the remaining parameter A_{Q} from Q-matrix equation 41. However, if Procedure 1 has determined that ϕ_{3rd} is equal to 0° or 180°, then A_{Q} can be directly assigned to 0. See steps 1232, 1234, and 1236.

When ϕ_{3rd} is not equal to 0° or 180° (1238), the workflow 1200 proceeds to iteratively solve for A_{Q} using a third iterative process. Note that the iterations for solving equation 41 are independent of iterations for solving equation 32. Before the third iterative process, or at the beginning of the third iterative process (e.g., starting from step 1240), an iteration count, e.g., k, representing a number of iterations of the third iterative process is set or reset to an initial value, e.g., 1. At iteration k, the third iterative process calculates (1240) Q measurements, \hat{Q}(t_{i,k-1}), based on the initial estimate [symbol] using equation 39, calculates (1240) the measurement estimation error y_{Q}(t_{i,k}) using equation 31, constructs Q-matrix equation 41, solves (1242) for unknowns Δ_{A}_{_{Q}} using the Least-Squares method, and updates (1242) [symbol] using equation 35. Meanwhile, a post-fix MSE_{Q,k} at each iteration is also calculated as follows:

$$M S {E}_{Q , k} = \frac{1}{n} {{\sum }_{i = 1}^{n} [ {y}_{Q} ( {t}_{i , k + 1} ) ]}^{2} \qquad ( 44 )$$

At the end of each iteration (e.g., iteration k), the workflow 1200 determines (1244) whether convergence of the third iterative process has occurred. A way of checking convergence is similar to that described above with respect to step 1214: if the change of estimates of A_{Q} in the last two iterations, e.g., | [symbol] − [symbol] |, is smaller than a threshold, and/or if the change in MSE_{Q}, i.e., |MSE_{Q,k}−MSE_{Q,k-1}|, is smaller than a threshold, and/or if MSE_{Q,k} itself is smaller than a threshold, then the third iterative process has successfully converged (1246), and thus A_{Q} is obtained (1248). Otherwise, if the third iterative process has not converged while the number of iterations, k, is larger than a threshold (e.g., Threshold5), this means that this process cannot converge and thus should be terminated with an output indicating that there is no valid solution (1248). A third possibility is that the third iterative process has not converged (1250) and that k is smaller than a threshold, then a new iteration with k=k+1 commences (1252).

To recap, the workflow 1200 in FIG. 12 describes the steps of solving for A_{I}, A_{Q}, Aₘ, and δ when ϕ_{3rd} is not equal to ±90°. In some instances, the iterative process (e.g., the second iterative process) for determining parameters A_{I}, Aₘ and δ, or the iterative process (e.g., the third iterative process) for determining A_{Q} can be stopped (e.g., when divergence occurs or when the numbers of iterations has exceeded a threshold number, such as Threshold4 or Threshold5) and information indicating that no valid solution has been determined is output.

FIG. 13 illustrates a workflow 1300 for solving for the unknown parameters A_{I}, A_{Q}, Aₘ, and δ when ϕ_{3rd} is equal to ±90° (step 1302, FIG. 13), in accordance with some embodiments. As discussed above, because Procedure 1 (workflow 900) has determined that ϕ_{3rd} is equal to ±90° using I(tᵢ) measurements based on equation 22, which is used to solve for A_{I}, there is no need to repeat this process of solving for some unknowns from I(tᵢ) measurements. Instead, the solution A_{I} to equation 22 obtained in Procedure 1 can be assigned not only to the initial estimate [symbol] but also to the final solution of A_{I}. The remaining steps in the workflow 1300 solve for A_{Q}, Aₘ and δ using matrix equation 33. In some embodiments, the steps for solving matrix equation 33, which are shown in the workflow 1300, are similar to those for solving matrix equation 32, which are shown on the left portion of the workflow 1200.

The workflow 1300 in FIG. 13 is an iterative process (e.g., a fourth iterative process) that includes calculating (1304) (e.g., at iteration k) Q measurements, \hat{Q}(t_{i,k-1}), based on initial estimates [symbol] , [symbol] and [symbol] using equation 29, calculating (1304) the estimation error y_{Q}(t_{i,k}) using equation 31, constructing Q-matrix equation 33, and solving (1306) for unknowns Δ_{A}_{_{Q}}, Δ_{A}_{ₘ} and Δ_{δ} using the Least-Squares method. Before the fourth iterative process, or at the beginning of the fourth iterative process (e.g., at step 1302), an iteration count, e.g., k, representing a number of iterations of the four iterative process is set or reset to an initial value, e.g., 1. The workflow 1300 includes updating (1308) [symbol] , [symbol] and [symbol] using equations 35, 36 and 37. Meanwhile, a post-fix MSE_{Q,k} at each iteration is also calculated using equation 44.

At the end of each iteration (e.g., iteration k) of the fourth iterative process, the workflow 1300 determines (1310) whether the iterative process has diverged or the number of iterations, k, is larger than a threshold (e.g., Threshold6). If estimates are out of their valid range (e.g., if estimate [symbol] is larger than the allowably maximal time delay corresponding to the last pair of correlators, tₙ, or if [symbol] is less than 0, or if estimate [symbol] is less than 0, then the iterative process is determined to have diverged (1320). In some embodiments, these thresholds may be fine-tuned to some margin, since [symbol] may oscillate to a slightly negative value before converging to a small positive one.

If the fourth iterative process has not diverged and the iteration count, k, for the fourth iterative process is smaller than a threshold (1312), the workflow 1300 determines whether the fourth iterative process has converged (1314). For example, if changes in the estimates between two latest iterations are smaller than the corresponding thresholds, and/or if the change in MSE_{Q}, i.e., |MSE_{Q,k}−MSE_{Q,k-1}|, is smaller than a threshold, and/or if MSE_{Q,k} itself is smaller than a threshold, then the workflow 1300 determines that the fourth iterative process has converged (1316). Otherwise, the workflow 1300 determines that the fourth iterative process has not converged. If the fourth iterative process has converged (1316), the Q-matrix equation 33 has been successfully solved, and the A_{Q}, Aₘ and δ are obtained (1318). Otherwise, the fourth iterative process has not converged (1328) and a new iteration with k=k+1 (1330) is executed (1330).

In some embodiments, if the fourth iterative process has diverged or if k is larger than a threshold (1320), then the current iteration is terminated, as illustrated in steps 1324 and 1326. In some embodiments, the workflow 1300 includes re-solving equation 33 using a new, different estimate [symbol] (1322). For example, in some embodiments, Procedure 2 selects different initial estimates [symbol] using the approach that is explained above with respect to FIG. 14. In some embodiments, if all candidates of initial estimates [symbol] have been tried, the fourth iterative process is terminated and the workflow 1300 outputs information indicating that no valid solution has been obtained (1326).

Referring again to FIG. 11, at this point, Procedure 2 has solved for parameters A_{I}, A_{Q}, Aₘ, and δ, regardless of whether ϕ_{3rd} is equal to ±90° or not. It is also possible that no valid solution is obtained in Procedure 1 and/or Procedure 2 (steps 110, 1112 and 1114). In some embodiments, if there is no valid solution, this means that no error correction to carrier or code phase measurements is available. The multipath error (if any) cannot be mitigated, and the receiver's performance is the same as that without phase multipath mitigation. According to some embodiments of the present disclosure, the phase multipath mitigation techniques output information indicating that there is not a valid solution, instead of a suspiciously bad solution, to protect GNSS receivers' reliability performance.

With continued reference to FIG. 11, if a valid solution for parameters A_{I}, A_{Q}, Aₘ, and δ is delivered (1115), all the remaining parameters can be calculated as well. Steps 1116, 1118 and 1120 of FIG. 11 show that when ϕ_{3rd} is not equal to ±90°, the carrier phase measurement error ϕ_{ε} can be calculated as follows:

$${ϕ}_{ε} = {tan}^{- 1} \frac{{A}_{Q}}{{A}_{I}} \qquad ( 45 )$$

Steps 1116, 1124, and 1126 of FIG. 11 show that when ϕ_{3rd} is equal to ±90°, error ϕ_{ε} can be calculated as follows instead:

$${ϕ}_{ε} = {tan}^{- 1} \frac{{A}_{m}}{{A}_{I}} \qquad ( 46 )$$

Regardless of whether ϕ_{3rd} is equal to ±90° or not, the amplitude A_{d} of the direct-path signal is:

$${A}_{d} = \sqrt{{A}_{I}^{2} + {A}_{Q}^{2}} \qquad ( 47 )$$

And ϕₘ can be calculated (1122) using equation 2. As a reminder, angles ϕ_{3rd}, ϕ_{ε} and ϕₘ are all positive if a triangle formed by three phasor vectors is in Quadrant 1 416, as illustrated in FIG. 4B; otherwise, they are all negative if the triangle is in Quadrant 4 418.

So far, all of the unknown parameters, including ϕ_{3rd}, ϕ_{ε}, ϕₘ, A_{I}, A_{Q}, Aₘ, A_{d}, Δt, and δ, have been solved. The carrier phase measurement error ϕ_{ε} can be used to correct the corresponding carrier phase measurement, and thus the carrier phase multipath error is mitigated. The time error Δt, if solved in Procedure 1, can be used as a reference to correct the corresponding code phase measurement and pseudorange measurement. In some embodiments, these parameters, whose values have been determined, can be further used, for example, to mitigate other errors using other signal tracking and multipath mitigation techniques.

Some applications solve for the carrier phase multipath error ϕ_{ε} and/or the time error Δt. In these instances, the steps (described above) that are used to calculate other parameters can be skipped as soon as ϕ_{ε} and Δt are obtained. For example, if Procedure 1 determines that ϕ_{3rd} is equal to 0° or 180°, then the entire Procedure 2 can be skipped and a correct solution to ϕ_{ε} can be directly delivered (ϕ_{ε} is equal to 0° in this case). Thus, depending which of the unknown parameters are of interest, computational power and time can be saved.

The above procedures can also work in instances where a multipath signal is weak or does not exist. Considering weak multipath or no-multipath scenarios, for example when Aₘ is close to 0, the I component of equation 7 will become equation 20. In other words, weak multipath and no-multipath scenarios will be detected as cases of ϕ_{3rd}=±90° in Procedure 1.

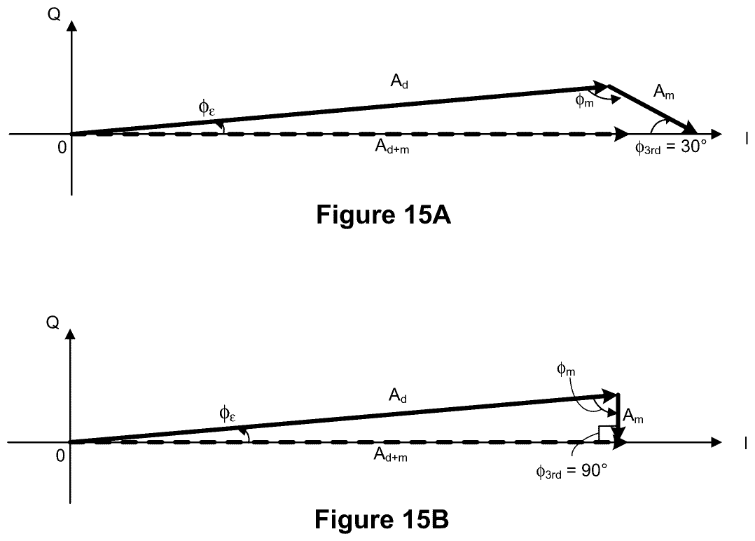

FIG. 15A illustrates a phasor diagram for a very weak multipath scenario with ϕ_{3rd}=30°. The geometry in FIG. 15A is assumed to reflect a weak multipath scenario, where the multipath signal amplitude Aₘ«A_{d}, and the value of the angle ϕ_{3rd} (“true value”) is equal to 30°.

FIG. 15B illustrates a correct solution to the carrier phase multipath error ϕ_{ε} even when the multipath scenario is detected as a case of ϕ_{3rd}=+90°. In this example, ϕ_{3rd} is detected to be 90° by Procedure 1, and then the steps described in FIG. 13 are executed, where low SNR measurements Q(tᵢ) are utilized, and these nearly zero-valued measurements Q(tᵢ) result in small values of solutions Aₘ and ϕ_{ε}. The comparison between FIG. 15A and FIG. 15B demonstrates that the solution for the carrier phase multipath error ϕ_{ε} in FIG. 15B is quite close to the ϕ_{ε} carrier phase multipath error in FIG. 15A, even though the solution ϕ_{3rd} could be very different from the “true value” of ϕ_{3rd}.

In some instances, weak multipath and no-multipath scenarios can also possibly be detected as cases of ϕ_{3rd}=0° or 180°, if they are not detected as cases of ϕ_{3rd}=±90° in Procedure 1. If this happens, FIG. 12 shows that solution A_{Q} will be equal to 0 for cases of ϕ_{3rd}=0° or 180°, and then equation 45 will result in a correct solution of ϕ_{ε}=0°.

Now that the phase multipath mitigation algorithm has been fully described, the code chip edge transition model SR(t) needs to be further discussed. Recall that FIG. 6 illustrates a code chip edge transition model SR(t). If the n data marks 602-i in FIG. 6 (representing n pairs of correlation measurements) only cover a portion of the transition, this will result in an ambiguity between multipath time delay δ and multipath signal amplitude Aₘ. In other words, this phase multipath mitigation may converge to a wrong solution or even diverge. Therefore, it is recommended that n pairs of correlation measurements should be arranged along the whole code chip edge transition including its tail.

In addition to a code chip edge transition model SR(t), FIG. 6 also illustrates its time-delayed version SR(t−δ). FIG. 6 shows that SR(t−δ) and the corresponding multipath signal may not be observable even by the last pair of receiver correlators if multipath time delay δ is too large, larger than the last correlator pair's code phase tₙ. In order to mitigate a long-delayed multipath, more correlator resources are needed in receiver hardware design to cover and measure the very tail part of the code chip edge transition model SR(t), if correlator spacing remains unchanged.

On the other hand, when multipath time delay δ is very small, the function SR(t) and SR(t−δ) will almost overlap in time, I(tᵢ) and Q(tᵢ) measurements of a direct-path signal and of a multipath can have a very similar pattern. Therefore, it can be very challenging for this phase multipath mitigation technique to estimate multipath parameters based on I(tᵢ) and Q(tᵢ) measurements of the corresponding composite signal. More correlators need to be densely arranged along code chip edge transitions if the system needs to mitigate a short-delayed multipath.

When the phase multipath mitigation system needs to deal with very short- and very long-delayed multipath scenarios, it demands more correlator resources. This tradeoff between receiver hardware complexity and multipath mitigation performance should be considered in GNSS receiver design. In some instances. when the receiver hardware does not have enough resources to support multipath mitigation for some multipath scenarios, the phase multipath mitigation algorithm that is described in Procedure 1 and Procedure 2 should determine the MSE values for most if not all steps, as described above, and deliver a no-solution as needed, to ensure that the receiver's reliability and integrity performance are protected.

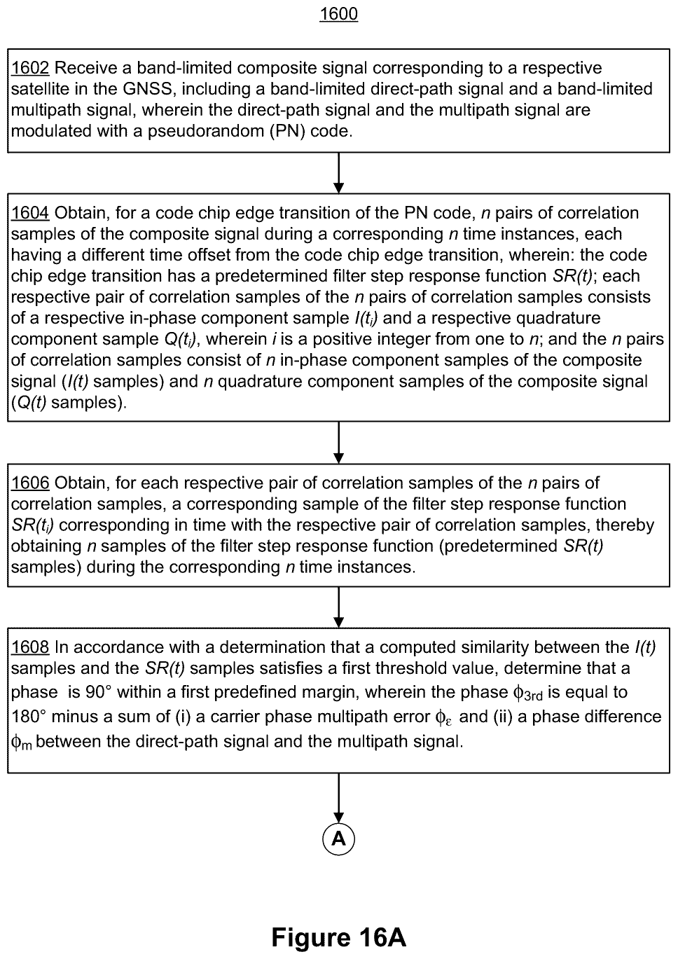

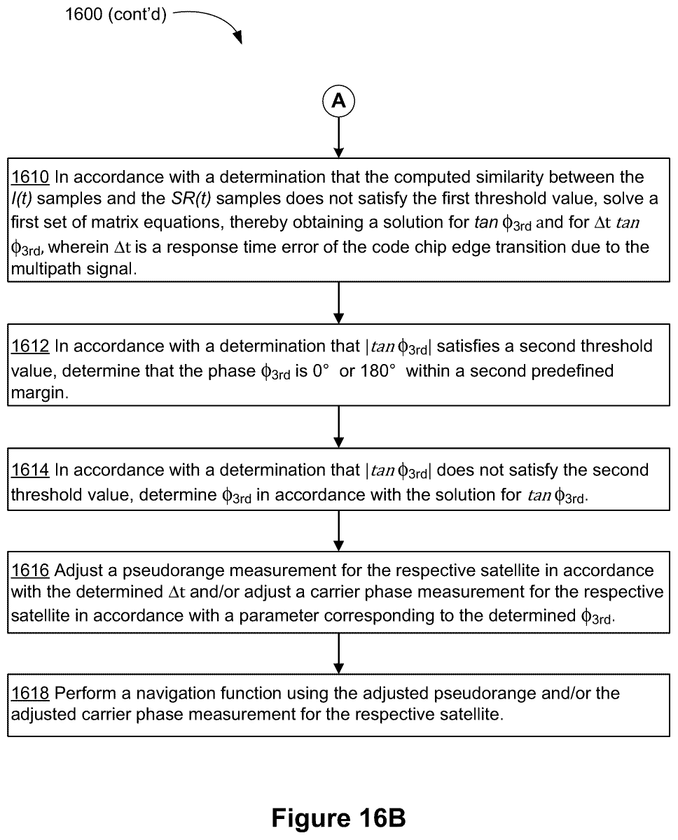

FIGS. 16A and 16B illustrate a flowchart diagram for a method 1600 of mitigating the effect of a multipath-induced error in a global navigation satellite system (GNSS), in accordance with some embodiments. In some embodiments, the method 1600 is performed at a GNSS receiver (e.g., navigation signal receiver 120 in FIG. 1A or GNSS receiver 170 in FIG. 1B), or at a computing device (e.g., computer system 130) that includes one or more processors (e.g., CPU(s) 202) and memory (e.g., memory 210). For ease of explanation, method 1600 will be explained as being performed by a GNSS receiver, but it will be understood that at least some portions of method 1600 could be performed by an external system.

The GNSS receiver receives (1602) a band-limited composite signal corresponding to a respective satellite in the GNSS, including a band-limited direct-path signal and a band-limited multipath signal. The direct-path signal and the multipath signal are modulated with a pseudorandom (PN) code

The GNSS receiver obtains (1604), for a code chip edge transition of the PN code (e.g., a chip edge-up transition or a chip edge-down transition), n pairs of correlation samples (e.g., samples 602-i, FIG. 6) of the composite signal during a corresponding n time instances, each having a different time offset from the code chip edge transition. In some embodiments, n is a positive integer such as 16, 32, 48, or the like. The code chip edge transition has a predetermined filter step response function SR(t) (see, e.g., FIG. 5). Each respective pair of correlation samples of the n pairs of correlation samples consists of a respective in-phase component sample I(tᵢ) and a respective quadrature component sample Q(tᵢ), wherein i is a positive integer from one to n. The n pairs of correlation samples consist of n in-phase component samples of the composite signal (I(t) samples) and n quadrature component samples of the composite signal (Q(t) samples).

In some embodiments, the n pairs of correlation samples are uniformly arranged along the code chip edge transition. In some embodiments, the n pairs of correlation are arranged over one period of correlation duration. In some embodiments, a respective pair of correlation samples (I(tᵢ), Q(tᵢ)) is summed or averaged over multiple periods of correlation duration. In some embodiments, the number of the pairs of correlation samples can be increased to cover a larger portion (e.g., even covering a tail portion) of the PN code sequence so as to accurately measure even long delayed multipath.

The GNSS receiver obtains (1606), for each respective pair of correlation samples of the n pairs of correlation samples, a corresponding sample of the filter step response function SR(tᵢ) corresponding in time with the respective pair of correlation samples, thereby obtaining n samples of the filter step response function (predetermined SR(t) samples) during the corresponding n time instances.

In accordance with a determination that a computed similarity between the I(t) samples and the SR(t) samples satisfies a first threshold value, the GNSS receiver determines (1608) that a phase ϕ_{3rd} is ±90° within a first predefined margin (e.g., no greater than 1, 2, 3, 4 or 5 degrees). The phase ϕ_{3rd} is equal to 180° minus a sum of (i) a carrier phase multipath error ϕ_{ε} (e.g., which can be used to correct carrier phase measurement) and (ii) a phase difference ϕₘ between the direct-path signal and the multipath signal (see Equation 2). In some embodiments, ϕₘ is equal to 180 degrees minus the difference between the direct-path signal and the multipath signal.

In accordance with a determination that the computed similarity between the I(t) samples and the SR(t) samples does not satisfy the first threshold value, the GNSS receiver solves (1610) a first set of matrix equations (e.g., Equation 17), thereby obtaining a solution for tan ϕ_{3rd} and for Δt tan ϕ_{3rd}, wherein Δt is a response time error of the code chip edge transition due to the multipath signal.

In accordance with a determination that |tan ϕ_{3rd}| satisfies a second threshold value (e.g., |tan ϕ_{3rd}|<Threshold2 or |tan ϕ_{3rd}|≤Threshold2, as illustrated in FIG. 9, step 920), the GNSS receiver determines (1612) that the phase ϕ_{3rd} is 0° or 180° within a second predefined margin (e.g., no greater 1, 0.5, 0.1, 0.01, or 0.001 degrees). In some embodiments, the second threshold value (e.g., Threshold2 in FIG. 9, step 920) is a small positive value to avoid any potential “divided by zero” error. In some embodiments, the second threshold value is a value such as 0.01 or less, with some examples being 0.0001, 0.001, 0.005, or 0.01.

In accordance with a determination that |tan ϕ_{3rd}| does not satisfy the second threshold value (see FIG. 9, step 926), the GNSS receiver determines (1614) ϕ_{3rd} in accordance with the solution for tan ϕ_{3rd} (see above discussion of FIG. 9, steps subsequent to step 926). For example, in some embodiments, |tan ϕ_{3rd}| does not satisfy the threshold value when |tan ϕ_{3rd}|>Threshold2 or |tan ϕ_{3rd}|>Threshold2.

The GNSS receiver adjusts (1616) a pseudorange measurement for the respective satellite in accordance with the determined Δt; and/or adjusts a carrier phase measurement for the respective satellite in accordance with a parameter (e.g., the carrier phase multipath error ϕ_{ε}) corresponding to the determined ϕ_{3rd}.

The GNSS receiver performs (1618) a navigation function (e.g., determines a location of the GNSS receiver) using the adjusted pseudorange and/or carrier phase measurements for the respective satellite.

In some embodiments, the GNSS receiver determines, based on the Q(t) samples, a sign (e.g., positive or negative) of the carrier phase multipath error Øg. For example, in some embodiments, if all Q(tᵢ) samples are positive, then the phasor diagram is in the first quadrant (e.g., Quadrant 1 416, FIG. 4B) and the sign of the carrier phase multipath error ϕ_{ε} is positive. In another example, if all Q(tᵢ) samples are negative, the phasor diagram is in the fourth quadrant (e.g., Quadrant 4 418) and the sign of the carrier phase multipath error ϕ_{ε} is negative. In some embodiments, some Q(tᵢ) are positive while some are negative. In this instance, the GNSS receiver finds the maximum of their magnitudes, say |Q(tⱼ)| is maximal, then the phasor diagram is in the first quadrant if Q(tᵢ) is positive and the phasor diagram is in the fourth quadrature if Q(tᵢ) is negative.

In some embodiments, the GNSS receiver determines a sign of the carrier phase multipath error ϕ_{ε} (e.g., positive or negative). In accordance with a determination that the computed similarity between the I(t) samples and the SR(t) samples satisfies (e.g., is less than, or is less than or equal to) the first threshold value (see FIG. 9, steps 906 and 908), the GNSS receiver determines that ϕ_{3rd} is +90° within the first predefined margin when the sign of the carrier phase multipath error ϕ_{ε} is positive, and determines that ϕ_{3rd} is −90° within the first predefined margin when the sign of the carrier phase multipath error ϕ_{ε} is negative.

In some embodiments, in accordance with a determination that the phase ϕ_{3rd} is 0° or 180° within the second predefined margin, the GNSS receiver determines a position of a peak of the I(t) samples relative to a position of a peak of the predetermined SR(t) samples. In accordance with a determination that the position of the peak of the I(t) samples (e.g., t_{I,peak} 1004 in FIG. 10A) occurs later in time than the position of the peak of the SR(t) samples (e.g., t_{mdl,peak} 1008 in FIG. 10A), the GNSS receiver determines that ϕ_{3rd} is 0° within the second predefined margin. In accordance with a determination that the position of the peak of the I(t) samples (e.g., t_{I,peak} 1014) occurs earlier in time than the position of the peak of the predetermined SR(t) samples (e.g., t_{mdl,peak} 1018), the GNSS receiver determines that ϕ_{3rd} is 180° within the second predefined margin. As described above with respect to FIGS. 10A and 10B, when ϕ_{3rd}=0°, the multipath signal is in phase with the direct-path signal and the peak of their composited correlations will shift to the right (i.e., get delayed). When ϕ_{3rd}=180°, the multipath signal is out of phase with the direct-path signal, and the peak of their composited correlations will shift to the left (e.g., be advanced).

In some embodiments, the computed similarity between the I(t) samples and the SR(t) samples is obtained using a mean squared error (MSE), defined by:

$$M S {E}_{{A}_{I}} = \frac{1}{n} {{\sum }_{i = 1}^{n} [ I ( {t}_{i} ) - {A}_{I} SR ( {t}_{i} ) ]}^{2}$$

(see Equation 23). Furthermore, in such embodiments, A_{I}=A_{d} cos ϕ_{ε}, where A_{d} is a magnitude of the direct-path signal, and ϕ_{ε} is the carrier phase multipath error.

In some embodiments, solving the first set of matrix equations comprises: obtaining (i) an initial estimate [symbol] for the phase ϕ_{3rd}, (ii) an initial estimate [symbol] for the response time error Δt, and (iii) an initial estimate [symbol] for a magnitude A_{d+m} of the composite signal (See FIG. 9, step 916). For example, in some embodiments, the initial estimate [symbol] is set to zero. In some embodiments, the initial estimate [symbol] is set to zero. In some embodiments, the initial estimate [symbol] is set as the magnitude of the last pair of correlation samples of the n pairs of correlation samples for code chip edge-up transitions, i.e., [symbol] =\sqrt{[I(tₙ)]²+[Q(tₙ)]²} (see Equation 24). In some embodiments, the initial estimate [symbol] is set as the magnitude of the first pair of correlation samples of the n pairs of correlation samples for code chip edge-down transitions, i.e., [symbol] ={square root over ([I(t₁)]²+[Q(t₁)]²))}. In some embodiments, the GNSS receiver uses the initial estimates [symbol] , [symbol] , and [symbol] to solve the first set of matrix equations (e.g., Equation 17) via a Least Squares fitting process to obtain the solution for tan ϕ_{3rd} and Δt tan ϕ_{3rd}.

In some embodiments, in accordance with the determination that |tan ϕ_{3rd}| does not satisfy the second threshold value (see, e.g., FIG. 9, step 926), the GNSS receiver obtains a solution for tan ϕ_{3rd} and Δt tan ϕ_{3rd} via a first iterative process. Each iteration of the first iterative process includes: obtaining an updated estimate tan [symbol] for the phase ϕ_{3rd} and an updated estimate [symbol] for the response time error Δt (e.g., according to Equations 18 and 19) (see, e.g., FIG. 9, step 928). In accordance with a determination that a number of iterations (e.g., the current number of iterations, k) for the first iterative process (e.g., iterations completed so far) satisfies a third threshold value (e.g., k>Threshold3 or k≥Threshold3 as illustrated in FIG. 9, steps 930 and 932): the GNSS receiver outputs information that no valid solution for ϕ_{3rd} has been determined (see, e.g., FIG. 9, step 934) and terminates the first iterative process without producing a solution for ϕ_{3rd}. For example, in some embodiments, if the number of iterations, k, for which the least squares fitting process satisfies the third threshold, the first iterative process has diverged (or at least cannot converge anymore) and therefore should be cancelled with a no valid solution. In some embodiments, each iteration of the first iterative process further includes: in accordance with a determination that the number of iterations for the first iterative process does not satisfy the third threshold value (e.g., k<Threshold3 or k≤Threshold3) (e.g., the first iterative process has not diverged, or the number of iterations, k, for the least squares fitting process does not equal or exceed a maximum value): in accordance with a determination that a magnitude based on the updated estimate [symbol] (e.g., | [symbol] |) or based on the updated estimate tan [symbol] (e.g., a difference in magnitude between the updated estimate tan [symbol] and the estimate tan [symbol] from the previous iteration, |tan [symbol] −tan [symbol] |) satisfies (e.g., is less than, or is less than or equal to) a fourth threshold value: determining that the Least Squares fitting process has converged (FIG. 9, step 932); outputting the updated estimate tan [symbol] and the updated estimate [symbol] as the solutions for tan ϕ_{3rd} and Δt, respectively (e.g., FIG. 9, step 934); calculating the phase ϕ_{3rd} from the updated estimate tan [symbol] (i.e., ϕ_{3rd}=tan⁻¹(tan [symbol] ) (FIG. 9, Step 934); and terminating the first iterative process. In some embodiments, each iteration of the first iterative process further includes: in accordance with a determination that the magnitude based on the updated estimate [symbol] or based on the updated estimate tan [symbol] does not satisfy the fourth threshold value, performing a next iteration of the first iterative process (see., e.g., FIG. 9, step 938). For example, in some embodiments, the magnitude based on the updated estimate [symbol] or based on the updated estimate tan [symbol] does not satisfy the fourth threshold value when [symbol] is greater than, or is greater than or equal to, the fourth threshold value, or when |tan [symbol] −tan [symbol] |) is greater than, or is greater than or equal to, the fourth threshold value.

In some embodiments, in accordance with a determination that a valid solution for the phase ϕ_{3rd} has been determined (e.g., when ϕ_{3rd} is one of: ±90° within the first predefined margin, 0° or 180° within the second predefined margin, or the updated estimate tan [symbol] ), the GNSS receiver determines (i) an initial estimate (e.g., a value) [symbol] for A_{I}, wherein A_{I}=A_{d} cos ϕ_{ε} (see Equation 21), A_{d} is a magnitude of the direct-path signal, and ϕ_{ε} is the carrier phase multipath error; (ii) an initial estimate [symbol] for a magnitude A_{Q}, wherein A_{Q}=A_{d} sin ϕ_{ε} (see Equation 27); (iii) an initial estimate [symbol] for a magnitude Aₘ of the multipath signal, and (iv) an initial estimate [symbol] for a time delay δ of the multipath signal relative to the direct-path signal (see, e.g., FIG. 11, step 1102). The GNSS receiver uses at least a subset of (i) the initial estimate [symbol] , (ii) the initial estimate [symbol] , (iii) the initial estimate [symbol] , and (iv) the initial estimate [symbol] as starting values, performing one or more iterative processes to obtain solutions for at least a subset of A_{I}, A_{Q}, Aₘ, and δ (e.g. using Procedure 2, as illustrated in FIGS. 11, 12, and 13). The GNSS receiver computes the carrier phase multipath error ϕ_{ε} in accordance with the obtained solutions for at least the subset of A_{I}, A_{Q}, Aₘ, and δ, and corrects the carrier phase measurement for the respective satellite in accordance with the carrier phase multipath error ϕ_{ε}.

In some embodiments, in accordance with a determination that a valid solution for the phase ϕ_{3rd} has been determined (e.g., when ϕ_{3rd} is one of: ±90° within the first predefined margin, 0° or 180° within the second predefined margin, or the updated estimate tan [symbol] ), the GNSS receiver determines (i) an initial estimate (e.g., a value) [symbol] for A_{I}, wherein A_{I}=A_{d} cos ϕ_{ε} (see Equation 21), A_{d} is a magnitude of the direct-path signal, and ϕ_{ε} is the carrier phase multipath error; (ii) an initial estimate [symbol] for a magnitude A_{Q}, wherein A_{Q}=A_{d} sin ϕ_{ε} (see Equation 27); (iii) an initial estimate [symbol] for a magnitude Aₘ of the multipath signal, and (iv) an initial estimate [symbol] for a time delay δ of the multipath signal relative to the direct-path signal. This is also illustrated in FIG. 11, step 1102.

In some embodiments, in accordance with a determination that the code chip edge transition is a code chip edge-up transition (and in accordance with the determination that the phase ϕ_{3rd} does not correspond to ±90° within the first predefined margin): the initial estimate [symbol] corresponds to a magnitude of a last in-phase component sample I(tₙ) of the I(t) samples; and the initial estimate [symbol] corresponds to a magnitude of a last quadrature component Q(tₙ) of the Q(t) samples.

In some embodiments, in accordance with the code chip edge transition is a code chip edge-down transition (and in accordance with the determination that the phase ϕ_{3rd} does not correspond to ±90° within the first predefined margin): the initial estimate [symbol] corresponds to a magnitude of a first in-phase component sample I(t₁) of the I(t) samples; and the initial estimate [symbol] corresponds to a magnitude of a first quadrature component Q(t₁) of the Q(t) samples.

In some embodiments, in accordance with the determination that the phase ϕ_{3rd} corresponds to ±90° within the first predefined margin, the GNSS receiver obtains a solution for A_{I} by solving a matrix equation

$$[ \begin{matrix}SR ( {t}_{1} ) \\ SR ( {t}_{2} ) \\ ⋮ \\ SR ( {t}_{n} )\end{matrix} ] {A}_{I} = [ \begin{matrix}I ( {t}_{1} ) \\ I ( {t}_{2} ) \\ ⋮ \\ I ( {t}_{n} )\end{matrix} ]$$

(see Equation 22), and assigning the obtained solution as the initial estimate [symbol] .

In some embodiments, in accordance with the determination that the phase ϕ_{3rd} is 0° or 180° within the second predefined margin, the GNSS receiver assigns the initial estimate [symbol] as zero.

In some embodiments, the initial estimate [symbol] is 0.5 (e.g., half of the amplitude that is used to normalize the chip edge transition model SR(t) and correlation samples I(tᵢ) and Q(tᵢ)). In some embodiments, for a very weak direct-path signal partially indicated by a small value of A_{I,0}, estimate [symbol] can be scaled down accordingly.

In some embodiments, in accordance with the determination that the phase ϕ_{3rd} does not correspond to ±90° within the first predefined margin (see, e.g., FIG. 11, step 1106), the GNSS receiver uses the initial estimates [symbol] , [symbol] , and [symbol] as starting values (e.g., obtained using equation 29) to obtain a solution for A_{I}, Aₘ, and δ via a second iterative process (see, e.g., workflow 1200 in FIG. 12). At the beginning of the second iterative process, an iteration count, e.g., k, representing a number of iterations of the second iterative process is set or reset to an initial value, e.g., 1. A k^{th} iteration of the second iterative process includes: obtaining n estimated in-phase component values (Î(tₖ₋₁) values) for the I(t) samples based on estimates [symbol] , [symbol] , and [symbol] from a previous (k−1)^{th} iteration of the second iterative process (e.g., using equation 29: Î(t_{i,k-1})= [symbol] SR(tᵢ)+ [symbol] SR(tᵢ− [symbol] cos ϕ_{3rd}) (see, e.g., FIG. 12, step 1204), determining, for each estimated in-phase component value Î(t_{i,k-1}) of the Î(tₖ₋₁) values, a corresponding in-phase component estimation error y_{I}(t_{i,k}) between (i) the respective estimated in-phase component value Î(t_{i,k-1}) and (ii) the respective in-phase component sample I(tᵢ) of the I(t) samples (e.g., using equation 31: y_{I}(t_{i,k})=I(tᵢ)−Î(t_{i,k-1})), thereby obtaining n in-phase component estimation errors (y_{I}(tₖ) estimation errors) (see, e.g., FIG. 12, step 1204); solving a second set of matrix equations (e.g., Equation 32) based on the y_{I}(tₖ) estimation errors, thereby obtaining (e.g., using the results produced by solving the second set of matrix equations) updated estimates [symbol] , [symbol] , and [symbol] for the k^{th} iteration (e.g., using equations 34, 36 and 37) (see, e.g., FIG. 12, step 1208). In accordance with a determination that (i) the updated estimate [symbol] is within a corresponding first valid range (e.g., the updated estimate [symbol] is greater than 0) and (ii) the updated estimate [symbol] is within a corresponding second valid range (e.g., [symbol] is within the allowably maximal time delay corresponding to the last pair of correlators, [symbol] is greater than 0 but less than tₙ) (i.e., the second iterative process has not diverged): in accordance with a determination that the number of iterations k satisfies a fifth threshold value (e.g., k satisfies the fifth threshold value when k<Threshold4 or k≤Threshold4, as illustrated in FIG. 12, steps 1210 and 1212): in accordance with a determination that a change in value of one or more predetermined first parameters between the k^{th} iteration and the (k−1)^{th} iteration satisfies a respective corresponding threshold, determining that the second iterative process has converged (see, e.g., FIG. 12, step 1216); outputting the updated estimates [symbol] , [symbol] , and [symbol] as the solution for A_{I}, Aₘ, and δ, respectively (see, e.g., FIG. 12, step 1218); and terminating the second iterative process.

In some embodiments, the one or more predetermined first parameters include one or more of A_{I}, Aₘ, and δ. In some embodiments, the determination that the second iterative process has converged is in accordance with a determination that (i) the change in an estimated value of A_{I} between the k^{th} iteration and the (k−1)^{th} iteration has a magnitude that is smaller than (or does not exceed) a corresponding threshold (i.e., | [symbol] − [symbol] |<Threshold_{AI}), and/or (ii) the change in an estimated value of Aₘ between the k^{th} iteration and the (k−1)^{th} iteration has a magnitude that is smaller than (or does not exceed) a corresponding threshold (i.e., | [symbol] − [symbol] |<Threshold_{AM}), and/or (iii) the change in an estimated value of δ between the k^{th} iteration and the (k−1)^{th} iteration has a magnitude that is smaller than (or does not exceed) a corresponding threshold (i.e., | [symbol] − [symbol] |<Threshold_{δ}). In some embodiments, the one or more predetermined first parameters include a post-fix mean squared error (MSE) for the in-phase component estimation error, defined by

$$M S {E}_{I , k} = \frac{1}{n} {{\sum }_{i = 1}^{n} [ {y}_{I} ( {t}_{i , k + 1} ) ]}^{2}$$

for the k^{th} iteration (see Equation 43). In some embodiments, the determining that the second iterative process has converged is in accordance with a determination that a change in the post-fix MSE for the in-phase component estimation error between the k^{th} iteration and the (k−1)^{th} iteration has a magnitude that is smaller than (or does not exceed) a corresponding threshold (i.e., |MSE_{I,k}−MSE_{I,k-1}|<Threshold_{MSE,I})).

In some embodiments, a k^{th} iteration of the second iterative process further includes, in accordance with the determination that the change in value of the one or more predetermined parameters between the k^{th} iteration and the (k−1)^{th} iteration does not satisfy the respective corresponding threshold (e.g., the second iterative process has not converged), performing a next iteration of the second iterative process (see, e.g., FIG. 12, steps 1220 and 1222). For example, in some embodiments, the change in value of the one or more predetermined parameters between the k^{th} iteration and the (k−1)^{th} iteration does not satisfy the respective corresponding threshold when | [symbol] − [symbol] |≥Threshold_{AI}, or | [symbol] − [symbol] |≥Threshold_{AM}, or | [symbol] − [symbol] |≥Threshold_{δ}), or |MSE_{I,k}−MSE_{I,k-1}|≥Threshold_{MSE,I}.

In some embodiments, a k^{th} iteration of the second iterative process further includes: in accordance with the determination that (i) the number of iterations k does not satisfy the fifth threshold value (e.g., k does not satisfy the fifth threshold value when k>Threshold4 or k≥Threshold4, as illustrated in FIG. 12, step 1210), terminating the second iterative process without producing a solution for A_{I}, Aₘ, and δ (see, e.g., FIG. 12, step 1231).

In some embodiments, in accordance with a determination that (i) the updated estimate [symbol] is not within the corresponding first valid range or (ii) the updated estimate [symbol] is not within the corresponding second valid range (i.e., the second iterative process has diverged), the GNSS receiver adjusts the initial estimate for the time delay δ from [symbol] to [symbol] (see, e.g., FIG. 12, step 1226). The GNSS receiver executes the second iterative process using the initial estimates [symbol] and [symbol] and the adjusted initial estimate [symbol] as the starting values.

In some embodiments, different initial estimates [symbol] can be tried using the pattern illustrated in FIG. 14. For example, if the first estimate 1402 [symbol] results in a divergence, a second new estimate 1404 [symbol] can be adjusted to a value that is larger than (e.g., to the right of) that of the first estimate 1402 [symbol] . If the second new estimate 1404 also fails, then a third new estimate 1406 [symbol] can be adjusted to a value that is smaller than (e.g., to left of) that of the first estimate 1402 [symbol] . If the third new estimate 1406 also fails, then a fourth new estimate 1408 [symbol] can be adjusted to a value that is larger than (e.g., to the right of) that of the second estimate 1404 [symbol] . In some embodiments, the adjustment step size can be a constant (e.g., equal to the correlator spacing).

In some embodiments, executing the second iterative process using the initial estimates [symbol] and [symbol] and the adjusted initial estimate [symbol] as the starting values includes: in accordance with a determination that (i) the updated estimate [symbol] (e.g., produced during a k^{th} iteration of the second iterative process) is not within the corresponding first valid range or (ii) the updated estimate [symbol] is not within the corresponding second valid range: in accordance with a determination that a next adjusted value for the time delay would fall within a range of time values for the n pairs of correlation samples, the GNSS receiver repeats the steps of adjusting the initial estimate for the time delay δ and executing the second iterative process (see, e.g., the path corresponding to steps 1226, 1228, and 1204 in FIG. 12), and otherwise (e.g., in accordance with a determination that a next adjusted value for the time delay would not fall within a range of time values for the n pairs of correlation samples), the GNSS receiver outputs information that no valid solution for A_{I}, Aₘ, and δ has been determined (see, e.g., FIG. 12, steps 1226, 1230, and 1231). In some embodiments, the adjustment range (e.g., tₘᵢₙ 1420 to tₘₐₓ 1422 in FIG. 14) for the time delay δ should cover all correlation sample times (e.g., from t₁ to tₙ) with some margin. Once an adjustment moves beyond this range, it means that all possible initial estimates in this corresponding direction have been tried. If adjustments have covered the whole range without producing an updated estimate [symbol] within the corresponding first valid range and an updated estimate [symbol] within the corresponding second valid range, the GNSS receiver stops the second iterative process and outputs information that there is a no valid solution (e.g., see, e.g., FIG. 12, steps 1230, 1231).

In some embodiments, after outputting the updated estimates [symbol] , [symbol] , and [symbol] as the solution for A_{I}, Aₘ, and δ, respectively, and in accordance with the determination that the phase ϕ_{3rd} is 0° or 180° within the second predefined margin: the GNSS receiver assigns a value of zero as the solution for A_{Q} (see, e.g., FIG. 12, steps 1218, 1232, 1234, and 1236).

In some embodiments, the GNSS receiver determines the carrier phase multipath error ϕ_{ε} based on the solutions for A_{I} and A_{Q} (e.g., using Equation 45:

$${ϕ}_{ε} = {tan}^{- 1} \frac{{A}_{Q}}{{A}_{I}} ) .$$

The GNSS receiver corrects the pseudorandom phase measurement for the respective satellite in accordance with the carrier phase multipath error ϕ_{ε}.

In some embodiments, after outputting the updated estimates [symbol] , [symbol] , and [symbol] as the solution for A_{I}, Aₘ, and δ, respectively (see, e.g., FIG. 12, step 1218), and in accordance with the determination that the phase ϕ_{3rd} is not 0° or 180° within the second predefined margin (see, e.g., FIG. 12, step 1238): the GNSS receiver starts with the initial estimate for [symbol] (e.g., see above discussion of step 1102, FIG. 11) and obtains a solution for A_{Q} via a third iterative process. In the third iterative process, k is a positive integer (e.g., starting from one (e.g., reset to 1 at step 1240 of the flowchart in FIG. 12) representing a number of iterations of the third iterative process. A k^{th} iteration of the third iterative process includes: obtaining n estimated quadrature component values (\hat{Q}(tₖ₋₁) values) for the Q(t) samples based on an initial estimate [symbol] (using Equation 39) from a previous (k−1)^{th} iteration of the third iterative process (see, e.g., FIG. 12, step 1240), or, in the case of the first iteration (k=1), using the aforementioned initial estimate [symbol] ; determining, for each estimated quadrature component value \hat{Q}(t_{i,k-1}) of the \hat{Q}(tₖ₋₁) values, a corresponding quadrature component estimation error y_{Q}(t_{i,k}) between (i) the respective estimated quadrature component value \hat{Q}(t_{i,k-1}) and (ii) the respective quadrature component sample Q(tᵢ) (e.g., using equation 31), thereby obtaining n quadrature component estimation errors (y_{Q}(tₖ) estimation errors) (see, e.g., FIG. 12, step 1240); solving a third set of matrix equations (Q-matrix equation 41) based on the y_{Q}(tₖ) estimation errors, thereby obtaining an updated estimate [symbol] for the k^{th} iteration (using equation 35); in accordance with a determination that the number of iterations k satisfies a sixth threshold value (e.g., k<Threshold5 or k≤Threshold5, as illustrated in FIG. 12, step 1244): in accordance with a determination that a change in value of one or more predetermined second parameters between the k^{th} iteration and the (k−1)^{th} iteration satisfies a respective corresponding threshold, determining that the third iterative process has converged (see. e.g., FIG. 12, step 1246); outputting the updated estimate [symbol] the solution for A_{Q} (see, e.g., FIG. 12 step 1248); and terminating the third iterative process.

For example, in some embodiments, the one or more predetermined second parameters include the parameter A_{Q}. In some embodiments, the determination that the third iterative process has converged is made in accordance with a determination that the change in an estimated value of A_{Q} between the k^{th} iteration and the (k−1)^{th} iteration has a magnitude that is smaller than (or does not exceed) a corresponding threshold (e.g., | [symbol] − [symbol] |<Threshold_{AQ}).). In some embodiments, the one or more predetermined second parameters include a post-fix mean squared error (MSE) for the quadrature component estimation error, defined by

$$M S {E}_{Q , j} = \frac{1}{n} {{\sum }_{i = 1}^{n} [ {y}_{Q} ( {t}_{i , k + 1} ) ]}^{2}$$

for the k^{th} iteration (See Equation 44). In some embodiments, the determining that the third iterative process has converged is in accordance with a determination that a change in the post-fix MSE for the quadrature component estimation error between the k^{th} iteration and the (k−1)^{th} iteration has a magnitude that is smaller than (or does not exceed) a corresponding threshold (i.e., |MSE_{Q,j}−MSE_{Q,k-1}|<Threshold_{MSE,Q}), and/or if MSE_{Q,k} itself is smaller than (or does not exceed) a corresponding threshold.

In some embodiments, the k^{th} iteration of the third iterative process further includes, in accordance with a determination that the change in value of the one or more predetermined second parameters between the k^{th} iteration and the (k−1)^{th} iteration does not satisfy a respective corresponding threshold, performing a next iteration of the third iterative process (see, e.g., FIG. 12, step 1252).

For example, in some embodiments, the change in value of the one or more predetermined second parameters between the k^{th} iteration and the (k−1)^{th} iteration does not satisfy a respective corresponding threshold when | [symbol] − [symbol] |≥Threshold_{AQ}), or when | [symbol] − [symbol] |>Threshold A_{Q}), or when |MSE_{Q,j}−MSE_{Q,j-1}|≥Threshold_{MSE,Q}), or when |MSE_{Q,k}−MSE_{Q,k-1}|>Threshold_{MSE,Q}).

In some embodiments, the k^{th} iteration of the third iterative process further includes: in accordance with the determination that the number of iterations j does not satisfy the sixth threshold value (e.g., k>Threshold5 or k≥Threshold5 in FIG. 12), terminating the third iterative process without producing a solution for A_{Q} (see, e.g., FIG. 12, steps 1244, 1246, and 1248).

In some embodiments, the GNSS receiver computes the carrier phase multipath error ϕ_{ε} based on the solutions for A_{I} and A_{Q} (using Equation 45:

$${ϕ}_{ε} = {tan}^{- 1} \frac{{A}_{Q}}{{A}_{I}} ) .$$

The GNSS receiver corrects the pseudorange measurement for the respective satellite in accordance with Δt and/or corrects the carrier phase measurement for the respective satellite in accordance with the carrier phase multipath error ϕ_{ε}.

In some embodiments, in accordance with the determination that the phase ϕ_{3rd} corresponds to ±90° within the first predefined margin (see, e.g., FIG. 11, step 1108): the GNSS receiver uses the initial estimates [symbol] , [symbol] , and [symbol] as starting values and obtains a solution for A_{Q}, Aₘ, and δ via a fourth iterative process (see, using workflow 1300 in FIG. 13). k is a positive integer (e.g., starting from one when the fourth iterative process begins) representing a number of iterations of the fourth iterative process. A k^{th} iteration of the fourth iterative process includes: obtaining n estimated quadrature component values (\hat{Q}(tₖ₋₁) values) for the Q(t) samples based on initial estimates [symbol] , [symbol] , and [symbol] from a previous (k−1)^{th} iteration of the fourth iterative process (e.g., using equation 29) (see, e.g., FIG. 13, step 1304), or for a first iteration of the fourth iterative process, based on previously determine initial estimates (e.g., as explained above with reference to step 1102, FIG. 11); determining, for each estimated quadrature component value \hat{Q}(t_{i,k-1}) of the \hat{Q}(tₖ₋₁) values, a respective quadrature component estimation error y_{Q}(t_{i,k}) between (i) the respective estimated quadrature component value \hat{Q}(t_{i,k-1}) and (ii) the respective quadrature component sample Q(tᵢ) (e.g., using equation 31) (see, e.g., FIG. 13, step 1304), thereby obtaining n quadrature component estimation errors (y_{Q}(tₖ) estimation errors); solving a fourth set of matrix equations (e.g., using Least Squares method) based on the y_{Q}(tₖ) estimation errors, thereby obtaining updated estimates [symbol] , [symbol] , and [symbol] for the k^{th} iteration (see, e.g., FIG. 13, step 1308). In accordance with a determination that (i) the updated estimate [symbol] is within a corresponding third valid range (e.g., the updated estimate [symbol] is greater than 0) and (ii) the updated estimate [symbol] is within a corresponding fourth valid range (e.g., [symbol] is within the allowably maximal time delay corresponding to the last pair of correlators (e.g., [symbol] is greater than 0 but less than tₙ)): in accordance with a determination that the number of iterations k satisfies a seventh threshold value (e.g., k<Threshold6 or k≤Threshold6, as illustrated in FIG. 13, steps 1310, 1312): in accordance with a determination that a change in value of one or more predetermined second parameters between the k^{th} iteration and the (k−1)^{th} iteration satisfies a respective corresponding threshold: determining that the fourth iterative process has converged (see, e.g., FIG. 13, step 1316); outputting the updated estimates [symbol] , [symbol] , and [symbol] as the solution for A_{Q}, Aₘ, and δ, respectively (see, e.g., FIG. 13, step 1318); and terminating the fourth iterative process.

For example, in some embodiments there are a few approaches for solving the fourth set of matrix equations. In one approach, equations 32 and 33 are solved separately, while estimates of A_{Q}, Aₘ and δ for equation 33 are updated based on equations 35, 36 and 37. In another approach, the two n×3 matrix equations (equations 32 and 33) are combined into one (2n)×4 matrix equation with a total of four unknowns (e.g., unknowns Δ_{A}_{_{I}}, Δ_{A}_{_{Q}}, Δ_{A}_{ₘ}, and Δ_{δ}), and the (2n)×4 matrix equation is solved (e.g., instead of combining solutions). In yet another approach, equation 32 is solved first, and then equation 41 is solved. In the latter approach, there is no need to solve equation 33 because it has been reduced to equation 41.

For example, in some embodiments, the one or more predetermined second parameters include one or more of A_{Q}, Aₘ, and δ. In some embodiments, the determination that the fourth iterative process has converged is made in accordance with a determination that (i) the change in an estimated value of A_{Q} between the k^{th} iteration and the (k−1)^{th} iteration has a magnitude that is smaller than (or does not exceed) a corresponding threshold (e.g., | [symbol] − [symbol] |<Threshold_{AI}), and/or (ii) the change in an estimated value of Aₘ between the k^{th} iteration and the (k−1)^{th} iteration has a magnitude that is smaller than (or does not exceed) a corresponding threshold (e.g., | [symbol] − [symbol] |<Threshold_{AM}), and/or (iii) the change in an estimated value of δ between the k^{th} iteration and the (k−1)^{th} iteration has a magnitude that is smaller than (or does not exceed) a corresponding threshold (e.g., | [symbol] − [symbol] |<Threshold_{δ}). In some embodiments, the one or more predetermined second parameters include a post-fix mean squared error (MSE) for the quadrature component estimation error, defined by

$$M S {E}_{Q , k} = \frac{1}{n} {{\sum }_{i = 1}^{n} [ {y}_{Q} ( {t}_{i , k + 1} ) ]}^{2}$$

for the k^{th} iteration (See Equation 4a). In some embodiments, determining that the fourth iterative process has converged is in accordance with a determination that a change in the post-fix MSE for the quadrature component estimation error between the k^{th} iteration and the (k−1)^{th} iteration has a magnitude that is smaller than (or does not exceed) a corresponding threshold (e.g., |MSE_{Q,k}−MSE_{Q,k-1}|<Threshold_{MSE,Q})).

In some embodiments, the k^{th} iteration of the fourth iterative process further includes: in accordance with the determination that the change in value of the one or more predetermined parameters between the k^{th} iteration and the (k−1)^{th} iteration does not satisfy the respective corresponding threshold (e.g., the fourth iterative process has not converged, see FIG. 13, Step 1328), performing a next iteration of the fourth iterative process (FIG. 13, Step 1330).

For example, in some embodiments, the change in value of the one or more predetermined parameters between the k^{th} iteration and the (k−1)^{th} iteration does not satisfy the respective corresponding threshold when | [symbol] − [symbol] |>Threshold_{AI}), or | [symbol] − [symbol] |≥Threshold_{AI}), or | [symbol] − [symbol] |>Threshold_{AM}), or | [symbol] − [symbol] |≥Threshold_{AM}), or | [symbol] − [symbol] |>Threshold_{δ}), or | [symbol] − [symbol] |≥Threshold_{δ}), or |MSE_{Q,k}−MSE_{Q,k-1}|>Threshold_{MSE,Q}), or |MSE_{Q,k}−MSE_{Q,k-1}|≥Threshold_{MSE,Q}).

In some embodiments, the k^{th} iteration of the fourth iterative process further includes: in accordance with the determination that the number of iterations k does not satisfy the seventh threshold value (e.g., k≥Threshold6 or k>Threshold6 in FIG. 13, step 1310) (e.g., the fourth iterative process has diverged or failed to converge), terminating the fourth iterative process without producing a solution for A_{Q} (see, e.g., FIG. 13, step 1326).

In some embodiments, in accordance with a determination that (i) the updated estimate [symbol] is not within a corresponding third valid range or (ii) the updated estimate [symbol] is not within a corresponding fourth valid range: the GNSS receiver updates the initial estimate for the time delay δ from [symbol] to [symbol] . The GNSS receiver executes the fourth iterative process (i.e., executes the fourth iterative process an additional time) using the initial estimates [symbol] and [symbol] and the updated initial estimate [symbol] as the starting values.

In some embodiments, the GNSS receiver uses the initial estimates [symbol] and [symbol] and the adjusted initial estimate [symbol] as the starting values. In accordance with a determination that (i) the updated estimate [symbol] is not within the corresponding third valid range or (ii) the updated estimate [symbol] is not within the corresponding fourth valid range: in accordance with a determination that a next adjusted value for the time delay would fall within a range of time values for the n pairs of correlation samples, the GNSS receiver repeats the steps of adjusting the initial estimate for the time delay δ and executing the fourth iterative process with the updated initial estimate for the time delay δ. Otherwise, the GNSS receiver outputs information that no valid solution for A_{Q}, Aₘ, and δ has been determined.

In some embodiments, in conjunction with outputting the updated estimates [symbol] , [symbol] , and [symbol] as the solution for A_{Q}, Aₘ, and δ, respectively, the GNSS receiver obtains a solution for A_{I} by solving a matrix equation

$$[ \begin{matrix}SR ( {t}_{1} ) \\ SR ( {t}_{2} ) \\ ⋮ \\ SR ( {t}_{n} )\end{matrix} ] {A}_{I} = [ \begin{matrix}I ( {t}_{1} ) \\ I ( {t}_{2} ) \\ ⋮ \\ I ( {t}_{n} )\end{matrix} ]$$

(See Equation 22). Because Procedure 1 (see workflow 900, FIG. 9) determines that ϕ_{3rd} is equal to ±90° (see steps 906, 908, 910, 912, FIG. 12, and step 1302, FIG. 13) using I(tᵢ) measurements based on the same equation, equation 22, use to solve for A_{I}, in Procedure 2 (see, e.g., workflow 1100 in FIG. 11 and workflow 1300 in FIG. 13), there is no need to repeat this process of solving for some unknowns from I(tᵢ) measurements. Instead, the solution A_{I} to equation 22 obtained in Procedure 1 can be assigned not only to the initial estimate [symbol] but also to the final solution of A_{I}.

In some embodiments, the GNSS receiver computes the carrier phase multipath error ϕ_{ε} based on the solution for A_{I} and the solution for Aₘ (e.g., using Equation 46). The GNSS receiver corrects the carrier phase measurement for the respective satellite in accordance with the carrier phase multipath error ϕ_{ε}. At this point, ϕ_{ε} and ϕ_{3rd} are known. The phase difference om can be computing by: ϕₘ=180°−(ϕ_{ε}+ϕ_{3rd}).

It will be understood that although the terms “first,” “second,” etc. may be used herein to describe various elements, these elements should not be limited by these terms. These terms are only used to distinguish one element from another. For example, a first contact could be termed a second contact, and, similarly, a second contact could be termed a first contact, without changing the meaning of the description, so long as all occurrences of the “first contact” are renamed consistently and all occurrences of the second contact are renamed consistently. The first contact and the second contact are both contacts, but they are not the same contact.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A device for mitigating the effect of a multipath-induced error in a global navigation satellite system (GNSS), comprising:
one or more processors; and
memory storing instructions that, when executed by the one or more processors, cause the device to perform operations, including:
receiving a band-limited composite signal corresponding to a respective satellite in the GNSS, including a band-limited direct-path signal and a band-limited multipath signal, wherein the direct-path signal and the multipath signal are modulated with a pseudorandom (PN) code;
obtaining, for a code chip edge transition of the PN code, n pairs of correlation samples of the composite signal during a corresponding n time instances, each having a different time offset from the code chip edge transition, wherein:
the code chip edge transition has a predetermined filter step response function SR(t);
each respective pair of correlation samples of the n pairs of correlation samples consists of a respective in-phase component sample I(tᵢ) and a respective quadrature component sample Q(tᵢ), wherein i is a positive integer from one to n; and
the n pairs of correlation samples consist of n in-phase component samples of the composite signal (I(t) samples) and n quadrature component samples of the composite signal (Q(t) samples);
obtaining, for each respective pair of correlation samples of the n pairs of correlation samples, a corresponding sample of the filter step response function SR(tᵢ) corresponding in time with the respective pair of correlation samples, thereby obtaining n samples of the filter step response function (predetermined SR(t) samples) during the corresponding n time instances;
in accordance with a determination that a computed similarity between the I(t) samples and the SR(t) samples satisfies a first threshold value, determining that a phase ϕ_{3rd} is ±90° within a first predefined margin, wherein the phase ϕ_{3rd} is equal to 180° minus a sum of (i) a carrier phase multipath error ϕ_{ε} and (ii) a phase difference ϕₘ between the direct-path signal and the multipath signal;
in accordance with a determination that the computed similarity between the I(t) samples and the SR(t) samples does not satisfy the first threshold value:
solving a first set of matrix equations, thereby obtaining a solution for tan ϕ_{3rd} and for Δt tan ϕ_{3rd}, wherein Δt is a response time error of the code chip edge transition due to the multipath signal;
in accordance with a determination that |tan ϕ_{3rd}| satisfies a second threshold value, determining that the phase ϕ_{3rd} is 0° or 180° within a second predefined margin; and
in accordance with a determination that |tan ϕ_{3rd}| does not satisfy the second threshold value, determining ϕ_{3rd} in accordance with the solution for tan ϕ_{3rd};
adjusting a pseudorange measurement for the respective satellite in accordance with the determined Δt; and/or adjusting a carrier phase measurement for the respective satellite in accordance with a parameter corresponding to the determined ϕ_{3rd}; and
performing a navigation function using the adjusted pseudorange and/or the adjusted carrier phase measurement for the respective satellite.

2. The device of claim 1, wherein the one or more programs further comprise instructions that, when executed by the one or more processors of the device, cause the device to perform operations, including:
determining a sign of the carrier phase multipath error ϕ_{ε};
in accordance with a determination that the computed similarity between the I(t) samples and the SR(t) samples satisfies the first threshold value:
determining that ϕ_{3rd} is +90° within the first predefined margin when the sign of the carrier phase multipath error ϕ_{ε} is positive; and
determining that ϕ_{3rd} is −90° within the first predefined margin when the sign of the carrier phase multipath error ϕ_{ε} is negative.

3. The device of claim 1, wherein the one or more programs further comprise instructions that, when executed by the one or more processors of the device, cause the device to perform operations, including:
in accordance with a determination that the phase ϕ_{3rd} is 0° or 180° within the second predefined margin:
determining a position of a peak of the I(t) samples relative to a position of a peak of the predetermined SR(t) samples;
in accordance with a determination that the position of the peak of the I(t) samples occurs later in time than the position of the peak of the SR(t) samples, determining that ϕ_{3rd} is 0° within the second predefined margin; and
in accordance with a determination that the position of the peak of the I(t) samples occurs earlier in time than the position of the peak of the predetermined SR(t) samples, determining that ϕ_{3rd} is 180° within the second predefined margin.

4. The device of claim 1, wherein the computed similarity between the I(t) samples and the SR(t) samples is obtained using a mean squared error (MSE), defined by
$${MSE}_{{A}_{I}} = \frac{1}{n} {{\sum }_{i = 1}^{n} [ I ( {t}_{i} ) - {A}_{I} SR ( {t}_{i} ) ]}^{2} ,$$
wherein A_{I}=A_{d} cos ϕ_{ε}, A_{d} is a magnitude of the direct-path signal, and de is the carrier phase multipath error.

5. The device of claim 1, wherein solving the first set of matrix equations comprises:
obtaining (i) an initial estimate [symbol] for the phase ϕ_{3rd}, (ii) an initial estimate [symbol] for the response time error Δt, and (iii) an initial estimate [symbol] for a magnitude A_{d+m} of the composite signal; and
using the initial estimates [symbol] , [symbol] , and [symbol] to solve the first set of matrix equations via a Least Squares fitting process to obtain the solution for tan ϕ_{3rd} and Δt tan ϕ_{3rd}.

6. The device of claim 5, wherein the one or more programs further comprise instructions that, when executed by the one or more processors of the device, cause the device to perform operations, including:
in accordance with the determination that |tan ϕ_{3rd}| does not satisfy the second threshold value, obtaining a solution for tan ϕ_{3rd} and Δt tan ϕ_{3rd} via a first iterative process, each iteration of the first iterative process including:
obtaining an updated estimate tan [symbol] for the phase ϕ_{3rd} and an updated estimate [symbol] for the response time error Δt;
in accordance with a determination that a number of iterations for the first iterative process satisfies a third threshold value:
outputting information that no valid solution for ϕ_{3rd} has been determined; and
terminating the first iterative process without producing a solution for ϕ_{3rd};
in accordance with a determination that a number of iterations for first iterative process does not satisfy the third threshold value:
in accordance with a determination that a magnitude based on the updated estimate [symbol] or based on the updated estimate tan [symbol] satisfies a fourth threshold value:
determining that the Least Squares fitting process has converged;
outputting the updated estimate tan [symbol] and the updated estimate [symbol] as the solutions for tan ϕ_{3rd} and Δt, respectively;
calculating the phase ϕ_{3rd} from the updated estimate tan [symbol] and
terminating the first iterative process; and
in accordance with a determination that (i) the magnitude based on the updated estimate [symbol] or based on the updated estimate tan [symbol] does not satisfy the fourth threshold value, performing a next iteration of the first iterative process.

7. The device of claim 1, wherein the one or more programs further comprise instructions that, when executed by the one or more processors of the device, cause the device to perform operations, including:
in accordance with a determination that a valid solution for the phase ϕ_{3rd} has been determined:
determining (i) an initial estimate [symbol] for A_{I}, wherein A_{I}=A_{d} cos ϕ_{ε}, A_{d} is a magnitude of the direct-path signal, and ϕ_{ε} is the carrier phase multipath error; (ii) an initial estimate [symbol] for a magnitude A_{Q}, wherein A_{Q}=A_{d} sin ϕ_{ε}; (iii) an initial estimate [symbol] for a magnitude Aₘ of the multipath signal, and (iv) an initial estimate [symbol] for a time delay δ of the multipath signal relative to the direct-path signal;
using at least a subset of (i) the initial estimate [symbol] , (ii) the initial estimate [symbol] (iii) the initial estimate [symbol] , and (iv) the initial estimate [symbol] as starting values, performing one or more iterative processes to obtain solutions for at least a subset of A_{I}, A_{Q}, Aₘ, and δ;
computing the carrier phase multipath error ϕ_{ε} in accordance with the obtained solutions for at least the subset of A_{I}, A_{Q}, Aₘ, and δ; and
correcting the carrier phase measurement for the respective satellite in accordance with the carrier phase multipath error ϕ_{ε}.

8. The device of claim 1, wherein the one or more programs further comprise instructions that, when executed by the one or more processors of the device, cause the device to perform operations, including:
in accordance with a determination that a valid solution for the phase ϕ_{3rd} has been determined:
determining (i) an initial estimate [symbol] for A_{I}, wherein A_{I}=A_{d} cos ϕ_{ε}, A_{d} is a magnitude of the direct-path signal, and ϕ_{ε} is the carrier phase multipath error; (ii) an initial estimate [symbol] for a magnitude A_{Q}, wherein A_{Q}=A_{d} sin ϕ_{ε}; (iii) an initial estimate [symbol] for a magnitude Aₘ of the multipath signal, and (iv) an initial estimate [symbol] for a time delay δ of the multipath signal relative to the direct-path signal.

9. The device of claim 8, wherein, in accordance with a determination that the code chip edge transition is a code chip edge-up transition:
the initial estimate [symbol] corresponds to a magnitude of a last in-phase component sample I(tₙ) of the I(t) samples; and
the initial estimate [symbol] corresponds to a magnitude of a last quadrature component Q(tₙ) of the Q(t) samples.

10. The device of claim 8, wherein, in accordance with the code chip edge transition is a code chip edge-down transition:
the initial estimate [symbol] corresponds to a magnitude of a first in-phase component sample I(t₁) of the I(t) samples; and
the initial estimate [symbol] corresponds to a magnitude of a first quadrature component Q(t₁) of the Q(t) samples.

11. The device of claim 8, wherein the one or more programs include instructions that, when executed by the one or more processors of the device, cause the device to perform operations, including:
in accordance with the determination that the phase ϕ_{3rd} corresponds to ±90° within the first predefined margin:
obtaining a solution for A, by solving a matrix equation
$$[ \begin{matrix}SR ( {t}_{1} ) \\ SR ( {t}_{2} ) \\ ⋮ \\ SR ( {t}_{n} )\end{matrix} ] {A}_{I} = [ \begin{matrix}I ( {t}_{1} ) \\ I ( {t}_{2} ) \\ ⋮ \\ I ( {t}_{n} )\end{matrix} ] ;$$
and
assigning the obtained solution as the initial estimate [symbol] .

12. The device of claim 8, wherein the one or more programs further comprise instructions that, when executed by the one or more processors of the device, cause the device to perform operations, including:
in accordance with the determination that the phase ϕ_{3rd} is 0° or 180° within the second predefined margin:
assigning the initial estimate [symbol] as zero.

13. The device of claim 8, wherein the initial estimate [symbol] is 0.5.

14. The device of claim 8, wherein the one or more programs include instructions that, when executed by the one or more processors of the device, cause the device to perform operations, including:
in accordance with the determination that the phase ϕ_{3rd} does not correspond to ±90° within the first predefined margin:
using the initial estimates [symbol] , [symbol] , and [symbol] as starting values to obtain a solution for A_{I}, Aₘ, and δ via a second iterative process, wherein k is a positive integer representing a number of iterations of the second iterative process and a k^{th} iteration of the second iterative process includes:
obtaining n estimated in-phase component values (Î(tₖ₋₁) values) for the I(t) samples based on estimates [symbol] , [symbol] , and [symbol] from a previous (k−1)^{th} iteration of the second iterative process;
determining, for each estimated in-phase component value Î(t_{i,k-1}) of the Î(tₖ₋₁) values, a corresponding in-phase component estimation error y_{I}(t_{i,k}) between (i) the respective estimated in-phase component value Î(t_{i,k-1}) and (ii) the respective in-phase component sample I(tᵢ) of the I(t) samples, thereby obtaining n in-phase component estimation errors (y_{I}(tₖ) estimation errors);
solving a second set of matrix equations based on the y_{I}(tₖ) estimation errors, thereby obtaining updated estimates [symbol] , [symbol] , and [symbol] for the k^{th} iteration;
in accordance with a determination that (i) the updated estimate [symbol] is within a corresponding first valid range and (ii) the updated estimate [symbol] is within a corresponding second valid range:
in accordance with a determination that the number of iterations k satisfies a fifth threshold value:
in accordance with a determination that a change in value of one or more predetermined first parameters between the k^{th} iteration and the (k−1)^{th} iteration satisfies a respective corresponding threshold:
determining that the second iterative process has converged;
outputting the updated estimates [symbol] , [symbol] , and [symbol] as the solution for A_{I}, Aₘ, and δ, respectively; and
terminating the second iterative process;
in accordance with the determination that the change in value of the one or more predetermined parameters between the k^{th} iteration and the (k−1)^{th} iteration does not satisfy the respective corresponding threshold, performing a next iteration of the second iterative process; and
in accordance with the determination that (i) the number of iterations k does not satisfy the fifth threshold value, terminating the second iterative process without producing a solution for A_{I}, Aₘ, and δ.

15. The device of claim 14, wherein the one or more programs include instructions that, when executed by the one or more processors of the device, cause the device to perform operations, including:
in accordance with a determination that (i) the updated estimate [symbol] is not within the corresponding first valid range or (ii) the updated estimate [symbol] is not within the corresponding second valid range:
adjusting the initial estimate for the time delay δ from [symbol] to [symbol] ; and
executing the second iterative process using the initial estimates [symbol] and [symbol] and the adjusted initial estimate [symbol] as the starting values.

16. The device of claim 15, wherein:
executing the second iterative process using the initial estimates [symbol] and [symbol] and the adjusted initial estimate [symbol] as the starting values includes:
in accordance with a determination that (i) the updated estimate [symbol] is not within the corresponding first valid range or (ii) the updated estimate [symbol] is not within the corresponding second valid range:
in accordance with a determination that a next adjusted value for the time delay would fall within a range of time values for the n pairs of correlation samples, repeating the steps of adjusting the initial estimate for the time delay & and executing the second iterative process; and
otherwise, outputting information that no valid solution for A_{I}, Aₘ, and δ has been determined.

17. The device of claim 14, wherein the one or more programs include instructions that, when executed by the one or more processors of the device, cause the device to perform operations, including:
after outputting the updated estimates [symbol] , [symbol] , and [symbol] as the solution for A_{I}, Aₘ, and δ, respectively, and in accordance with the determination that the phase ϕ_{3rd} is 0° or 180° within the second predefined margin:
assigning a value of zero as the solution for A_{Q}.

18. The device of claim 17, wherein the one or more programs include instructions that, when executed by the one or more processors of the device, cause the device to perform operations, including:
determining the carrier phase multipath error ϕ_{ε} based on the solutions for A_{I} and A_{Q}; and
correcting a pseudorandom phase measurement for the respective satellite in accordance with the carrier phase multipath error ϕ_{ε}.

19. The device of claim 14, wherein the one or more programs include instructions that, when executed by the one or more processors of the device, cause the device to perform operations, including:
after outputting the updated estimates [symbol] , [symbol] , and [symbol] as the solution for A_{I}, Aₘ, and δ, respectively, and in accordance with the determination that the phase ϕ_{3rd} is not 0° or 180° within the second predefined margin:
starting with the initial estimate for [symbol] , obtaining a solution for A_{Q} via a third iterative process, wherein k is a positive integer representing a number of iterations of the third iterative process and a k^{th} iteration of the third iterative process includes:
obtaining n estimated quadrature component values (\hat{Q}(tₖ₋₁) values) for the Q(t) samples based on an initial estimate [symbol] from a previous (k−1)^{th} iteration of the third iterative process;
determining, for each estimated quadrature component value \hat{Q}(t_{i,k-1}) of the \hat{Q}(tₖ₋₁) values, a corresponding quadrature component estimation error y_{Q}(t_{i,k}) between (i) the respective estimated quadrature component value \hat{Q}(t_{i,k-1}) and (ii) the respective quadrature component sample Q(tᵢ), thereby obtaining n quadrature component estimation errors (y_{Q}(tₖ) estimation errors);
solving a third set of matrix equations based on the y_{W}(tₖ) estimation errors, thereby obtaining an updated estimate [symbol] for the k^{th} iteration;
in accordance with a determination that the number of iterations k satisfies a sixth threshold value:
in accordance with a determination that a change in value of one or more predetermined second parameters between the k^{th} iteration and the (k−1)^{th} iteration satisfies a respective corresponding threshold:
determining that the third iterative process has converged;
outputting the updated estimate [symbol] the solution for A_{Q}; and
terminating the third iterative process;
in accordance with a determination that the change in value of the one or more predetermined second parameters between the k^{th} iteration and the (k−1)^{th} iteration does not satisfy a respective corresponding threshold, performing a next iteration of the third iterative process; and
in accordance with the determination that (i) the number of iterations k does not satisfy the sixth threshold value, terminating the third iterative process without producing a solution for A_{Q}.

20. The device of claim 19, wherein the one or more programs include instructions that, when executed by the one or more processors of the device, cause the device to perform operations, including:
computing the carrier phase multipath error ϕ_{ε} based on the solutions for A_{I} and A_{Q}; and
correcting the pseudorange measurement for the respective satellite in accordance with Δt; and
correcting the carrier phase measurement for the respective satellite in accordance with the carrier phase multipath error ϕ_{ε}.

21. The device of claim 8, wherein the one or more programs include instructions that, when executed by the one or more processors of the device, cause the device to perform operations, including:
in accordance with the determination that the phase ϕ_{3rd} corresponds to ±90° within the first predefined margin:
using the initial estimates [symbol] , [symbol] , and [symbol] as starting values, obtaining a solution for A_{Q}, Aₘ, and δ via a fourth iterative process, wherein k is a positive integer representing a number of iterations of the fourth iterative process and a k^{th} iteration of the fourth iterative process includes:
obtaining n estimated quadrature component values (\hat{Q}(tₖ₋₁) values) for the Q(t) samples based on initial estimates [symbol] , [symbol] , and [symbol] from a previous (k−1)^{th} iteration of the fourth iterative process;
determining, for each estimated quadrature component value \hat{Q}(t_{i,k-1}) of the \hat{Q}(tₖ₋₁) values, a respective quadrature component estimation error y_{Q}(t_{i,k}) between (i) the respective estimated quadrature component value \hat{Q}(t_{i,k-1}) and (ii) the respective quadrature component sample Q(tᵢ), thereby obtaining n quadrature component estimation errors (y_{Q}(tₖ) estimation errors);
solving a fourth set of matrix equations based on the y_{Q}(tₖ) estimation errors, thereby obtaining updated estimates [symbol] , [symbol] , and [symbol] for the k^{th} iteration;
in accordance with a determination that (i) the updated estimate [symbol] is within a corresponding third valid range and (ii) the updated estimate [symbol] is within a corresponding fourth valid range:
in accordance with a determination that the number of iterations k satisfies a seventh threshold value:
in accordance with a determination that a change in value of one or more predetermined second parameters between the k^{th} iteration and the (k−1)^{th} iteration satisfies a respective corresponding threshold:
determining that the fourth iterative process has converged;
outputting the updated estimates [symbol] , [symbol] , and [symbol] as the solution for A_{Q}, Aₘ, and δ, respectively; and
terminating the fourth iterative process;
in accordance with the determination that the change in value of the one or more predetermined parameters between the k^{th} iteration and the (k−1)^{th} iteration does not satisfy the respective corresponding threshold, performing a next iteration of the fourth iterative process; and
in accordance with the determination that (i) the number of iterations k does not satisfy the seventh threshold value, terminating the fourth iterative process without producing a solution for A_{Q}.

22. The device of claim 21, wherein the one or more programs include instructions that, when executed by the one or more processors of the device, cause the device to perform operations, including:
in accordance with a determination that (i) the updated estimate [symbol] is not within a corresponding third valid range or (ii) the updated estimate [symbol] is not within a corresponding fourth valid range:
updating the initial estimate for the time delay δ from [symbol] to [symbol] ; and
executing the fourth iterative process using the initial estimates [symbol] and [symbol] and the updated initial estimate [symbol] as the starting values.

23. The device of claim 22, wherein the one or more programs include instructions that, when executed by the one or more processors of the device, cause the device to perform operations, including:
using the initial estimates [symbol] and [symbol] and the adjusted initial estimate [symbol] as the starting values:
in accordance with a determination that (i) the updated estimate [symbol] is not within the corresponding third valid range or (ii) the updated estimate [symbol] is not within the corresponding fourth valid range:
in accordance with a determination that a next adjusted value for the time delay would fall within a range of time values for the n pairs of correlation samples, repeating the steps of updating the initial estimate for the time delay δ and executing the fourth iterative process; and
otherwise, outputting information that no valid solution for A_{Q}, Aₘ, and δ has been determined.

24. The device of claim 21, wherein the one or more programs include instructions that, when executed by the one or more processors of the device, cause the device to perform operations, including:
in conjunction with outputting the updated estimates [symbol] , [symbol] , and [symbol] as the solution for A_{Q}, Aₘ, and δ, respectively:
obtaining a solution for A_{I} by solving a matrix equation
$$[ \begin{matrix}SR ( {t}_{1} ) \\ SR ( {t}_{2} ) \\ ⋮ \\ SR ( {t}_{n} )\end{matrix} ] {A}_{I} = [ \begin{matrix}I ( {t}_{1} ) \\ I ( {t}_{2} ) \\ ⋮ \\ I ( {t}_{n} )\end{matrix} ] .$$

25. The device of claim 24, wherein the one or more programs include instructions that, when executed by the one or more processors of the device, cause the device to perform operations, including:
computing the carrier phase multipath error ϕ_{ε} based on the solution for A_{I} and the solution for Aₘ; and
correcting the carrier phase measurement for the respective satellite in accordance with the carrier phase multipath error ϕ_{ε}.

26. A method of mitigating the effect of a multipath-induced error in a global navigation satellite system (GNSS), performed at a respective GNSS signal receiver, comprising:
receiving a band-limited composite signal corresponding to a respective satellite in the GNSS, including a band-limited direct-path signal and a band-limited multipath signal, wherein the direct-path signal and the multipath signal are modulated with a pseudorandom (PN) code;
obtaining, for a code chip edge transition of the PN code, n pairs of correlation samples of the composite signal during a corresponding n time instances, each having a different time offset from the code chip edge transition, wherein:
the code chip edge transition has a predetermined filter step response function SR(t);
each respective pair of correlation samples of the n pairs of correlation samples consists of a respective in-phase component sample I(tᵢ) and a respective quadrature component sample Q(tᵢ), wherein i is a positive integer from one to n; and
the n pairs of correlation samples consist of n in-phase component samples of the composite signal (I(t) samples) and n quadrature component samples of the composite signal (Q(t) samples);
obtaining, for each respective pair of correlation samples of the n pairs of correlation samples, a corresponding sample of the filter step response function SR(tᵢ) corresponding in time with the respective pair of correlation samples, thereby obtaining n samples of the filter step response function (predetermined SR(t) samples) during the corresponding n time instances;
in accordance with a determination that a computed similarity between the I(t) samples and the SR(t) samples satisfies a first threshold value, determining that a phase ϕ_{3rd} is ±90° within a first predefined margin, wherein the phase ϕ_{3rd} is equal to 180° minus a sum of (i) a carrier phase multipath error ϕ_{ε} and (ii) a phase difference ϕₘ between the direct-path signal and the multipath signal;
in accordance with a determination that the computed similarity between the I(t) samples and the SR(t) samples does not satisfy the first threshold value:
solving a first set of matrix equations, thereby obtaining a solution for tan ϕ_{3rd} and for Δt tan ϕ_{3rd}, wherein Δt is a response time error of the code chip edge transition due to the multipath signal;
in accordance with a determination that |tan ϕ_{3rd}| satisfies a second threshold value, determining that the phase ϕ_{3rd} is 0° or 180° within a second predefined margin; and
in accordance with a determination that |tan ϕ3_{rd}| does not satisfy the second threshold value, determining ϕ_{3rd} in accordance with the solution for tan ϕ_{3rd};
adjusting a pseudorange measurement for the respective satellite in accordance with the determined Δt; and/or adjusting a carrier phase measurement for the respective satellite in accordance with a parameter corresponding to the determined ϕ_{3rd}; and
performing a navigation function using the adjusted pseudorange and/or the adjusted carrier phase measurement for the respective satellite.

27. A computer-readable storage medium having stored thereon program code instructions that, when executed a respective global navigation satellite system (GNSS) receiver having one or more processors, cause the GNSS receiver to perform a set of operations, including:
receiving a band-limited composite signal corresponding to a respective satellite in a global navigation satellite system (GNSS), including a band-limited direct-path signal and a band-limited multipath signal, wherein the direct-path signal and the multipath signal are modulated with a pseudorandom (PN) code;
obtaining, for a code chip edge transition of the PN code, n pairs of correlation samples of the composite signal during a corresponding n time instances, each having a different time offset from the code chip edge transition, wherein:
the code chip edge transition has a predetermined filter step response function SR(t);
each respective pair of correlation samples of the n pairs of correlation samples consists of a respective in-phase component sample I(tᵢ) and a respective quadrature component sample Q(tᵢ), wherein i is a positive integer from one to n; and
the n pairs of correlation samples consist of n in-phase component samples of the composite signal (I(t) samples) and n quadrature component samples of the composite signal (Q(t) samples);
obtaining, for each respective pair of correlation samples of the n pairs of correlation samples, a corresponding sample of the filter step response function SR(tᵢ) corresponding in time with the respective pair of correlation samples, thereby obtaining n samples of the filter step response function (predetermined SR(t) samples) during the corresponding n time instances;
in accordance with a determination that a computed similarity between the I(t) samples and the SR(t) samples satisfies a first threshold value, determining that a phase ϕ_{3rd} is ±90° within a first predefined margin, wherein the phase ϕ_{3rd} is equal to 180° minus a sum of (i) a carrier phase multipath error ϕ_{ε} and (ii) a phase difference ϕₘ between the direct-path signal and the multipath signal;
in accordance with a determination that the computed similarity between the I(t) samples and the SR(t) samples does not satisfy the first threshold value:
solving a first set of matrix equations, thereby obtaining a solution for tan ϕ_{3rd} and for Δt tan ϕ_{3rd}, wherein Δt is a response time error of the code chip edge transition due to the multipath signal;
in accordance with a determination that |tan ϕ_{3rd}| satisfies a second threshold value, determining that the phase ϕ_{3rd} is 0° or 180° within a second predefined margin; and
in accordance with a determination that |tan ϕ_{3rd}| does not satisfy the second threshold value, determining 3rd in accordance with the solution for tan ϕ_{3rd};
adjusting a pseudorange measurement for the respective satellite in accordance with the determined Δt; and/or adjusting a carrier phase measurement for the respective satellite in accordance with a parameter corresponding to the determined ϕ_{3rd}; and
performing a navigation function using the adjusted pseudorange and/or the adjusted carrier phase measurement for the respective satellite.
